(19) United States
(12) Patent Application Publication
(10) Pub. No.: US 2002/0016655 A1
(43) Pub. Date: Feb. 7, 2002

(54) Apparatus and method for processing and/or for providing vehicle information and/or vehicle maintenance information

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 09/919,279

(22) Filed: Jul. 31, 2001

Related U.S. Application Data
(60) Provisional application No. 60/222,623, filed on Aug. 1, 2000.

(51) Int. Cl. G06F 19/00

(52) U.S. Cl. 701/35; 340/438

(57) ABSTRACT

An apparatus and method for processing vehicle information and/or vehicle maintenance information, including a memory device for storing at least one of vehicle diagnostic information, vehicle repair information, vehicle maintenance information, and vehicle servicing information, a receiver for receiving information regarding at least one of a vehicle problem, a vehicle malfunction, and a vehicle state of disrepair, a processor for processing the information regarding at least one of a vehicle problem, a vehicle malfunction, and a vehicle state of disrepair, in conjunction with at least one of vehicle diagnostic information, vehicle repair information, vehicle maintenance information, and vehicle servicing information, wherein the processor generates at least one of a diagnostic report, a repair report, a maintenance report, and a servicing report, and a transmitter for transmitting at least one of the at least one of vehicle diagnostic information, vehicle repair information, vehicle maintenance information, and vehicle servicing information, to a communication device associated with an individual.

### RELATED APPLICATIONS

This application claims the benefit of priority of U.S. Provisional Patent Application Ser. No. 60/222,623 filed Aug. 1, 2000, and entitled “APPARATUS AND METHOD FOR PROCESSING AND/OR FOR PROVIDING VEHICLE INFORMATION AND/OR VEHICLE MAINTENANCE INFORMATION”, the subject matter of which is hereby incorporated by reference herein.

### FIELD OF THE INVENTION

The present invention pertains to an apparatus and a method for processing and/or for providing vehicle information and/or vehicle maintenance information and, in particular, to an apparatus and a method for processing and/or for providing vehicle information and/or vehicle maintenance information for a variety of vehicle maintenance, vehicle servicing, and vehicle-related applications.

### BACKGROUND OF THE INVENTION

Hundreds of millions of vehicles of all types are in service today around the world. These vehicles include motor vehicles, automobiles, cars, motorcycles, trucks, commercial vehicles, commercial transportation vehicles, boats, marine vehicles, airplanes, jets, aircraft, spacecraft, and the list can go on and on. These vehicles inevitably require to be maintained, repaired, and/or serviced, at some points during their operating life.

Unfortunately, the vast majority of individuals or entities who or which own, operate, and/or use, these vehicles, are usually unable to, and/or are usually not equipped to, perform repairs, maintenance procedures, or servicing procedures, on their vehicles. As a result, the vast majority of individuals usually must rely on others for vehicle repairs, vehicle maintenance, and/or vehicle servicing. As a result, millions of individuals must rely on others in order to repair, maintain, and/or service, their respective vehicles. It is also no surprise that vehicle repairs, vehicle maintenance, and/or vehicle servicing, can be very expensive.

As vehicle technology has advanced, vehicles and vehicle systems have also become more complex. The complexity of vehicles and vehicle systems has further added to the costs of vehicle repairs, vehicle maintenance, and/or vehicle servicing.

Millions of individuals simply do not understand and/or know how to repair, maintain, and/or service, vehicles. Further, by not understanding vehicle maintenance practices, many individuals may often wait until it is too late to service their vehicles. At that point, costly repairs or servicing may be required which can also sometimes include costs and expenses which may be incurred relating to a need to replace expensive parts, components, and/or equipment.

Vehicle maintenance and repairs may also involve many parties, including, but not limited to, the owners and users of the vehicles, vehicle manufacturers, vehicle dealers, vehicle service providers, vehicle parts providers, vehicle component providers, vehicle equipment providers, vehicle accessory providers, vehicle insurance providers, vehicle service payers, and/or any other intermediaries which may act for, or on behalf of, any of these individuals and/or entities.

Vehicle maintenance and repairs can also involve the need for vehicle information and/or vehicle maintenance information. While vehicle technology has continued to develop and advance, the development of technology for providing information regarding vehicle repair, vehicle maintenance, and/or vehicle servicing, appears to have been left far behind.

### SUMMARY OF THE INVENTION

The present invention pertains to an apparatus and a method for processing and/or for providing vehicle information and/or vehicle maintenance information which overcomes the shortfalls of the prior art. The present invention also pertains to an apparatus and a method for processing and/or for providing vehicle information and/or vehicle maintenance information for a variety of vehicle maintenance, vehicle servicing, and vehicle-related applications.

The apparatus and method of the present invention facilitates the creation and management of a comprehensive vehicle maintenance processing system which can manage vehicle information and/or records, vehicle maintenance information and/or records, vehicle owner and/or operator information and/or records, vehicle service information and/or records, vehicle dealer information and/or records, service provider information and/or records, vehicle parts provider information and/or records, vehicle manufacturer information and/or records, and/or vehicle service payer information and/or records.

The present invention facilitates improved vehicle maintenance, improved vehicle maintenance quality, improved vehicle maintenance record-keeping, efficient vehicle information collection, processing and dissemination, efficient vehicle diagnosis and servicing, cost efficiency, cost containment, as well as many other benefits and advantages as will be described herein.

The apparatus and method of the present invention also facilitates the distribution and management of vehicle maintenance information, vehicle servicing information, as well as the any other vehicle information and/or vehicle-related information.

The present invention also provides an apparatus and a method for providing a comprehensive processing system for providing a comprehensive database of, and processing system for, data and/or information for or from any combination of vehicles and/or participants in the vehicle maintenance and/or vehicle servicing fields, including, but not limited to, users, vehicle owners, vehicle operators, vehicle manufacturers, vehicle dealers, vehicle service providers, vehicle parts providers, vehicle insurers, vehicle insurance providers, vehicle service payers, vehicle warranty providers, vehicle managers, vehicle maintenance managers, and/or any agents, brokers, and/or intermediaries and/or third parties, who or which acts on behalf of another and/or assists in to providing vehicle, vehicle maintenance, and/or related services.

The apparatus of the present invention includes a central processing computer or communication device. The central processing computer or communication device can provide control over the apparatus and can perform any of the various processing services and/or functions described herein.

The central processing computer or communication device can also provide services for any of the other computer or communication devices described herein as being associated with any of the users, vehicle owners, vehicle operators, vehicle manufacturers, vehicle dealers, vehicle service providers, vehicle parts providers, vehicle insurers, vehicle insurance providers, vehicle service payers, vehicle warranty providers, vehicle managers, vehicle maintenance managers, and/or any agents, brokers, and/or intermediaries and/or third parties who or which acts on behalf of another.

The apparatus can also include a user computer or communication device which can be associated with a user of the apparatus and method of the present invention, a vehicle owner, a vehicle user, and/or any other individual who or which utilizes the apparatus and method of the present invention and/or any of the services described herein.

The apparatus can also include a vehicle computer or communication device, which can be associated with any of the vehicles described herein, a vehicle dealer computer or communication device which can be associated with a vehicle dealer who or which utilizes the apparatus and method of the present invention, and/or a vehicle manufacturer computer or communication device which can be associated with a vehicle manufacturer, who or which utilizes the apparatus and method of the present invention.

The apparatus can also include in a vehicle service provider computer or communication device which can be associated with a vehicle service provider, and/or a vehicle parts provider computer or communication device which can be associated with a vehicle parts provider.

The apparatus can also include a vehicle service payer computer or communication device which can be associated with a vehicle service payer, a vehicle manufacturer, a vehicle warranty provider, a vehicle extended warranty provider, a vehicle warranty insurance provider, and/or any other vehicle service payer, who or which utilizes the apparatus and method of the present invention.

The apparatus can also include a vehicle insurance provider computer or communication device which can be associated with an insurance provider, an insurance company, a vehicle insurance provider, a vehicle insurance company, a vehicle manufacturer, a vehicle warranty provider, a vehicle extended warranty provider, vehicle warranty insurance provider, and/or any other insurance provider, who or which utilizes the apparatus and method of the present invention.

The apparatus can also include an intermediary computer or communication device which can be associated with any agent, broker, third party, and/or intermediary, who or which acts on behalf of any of users, vehicle owners, vehicle users, vehicle operators, vehicle manufacturers, vehicle dealers, vehicle service providers, vehicle parts providers, vehicle insurers, vehicle insurance providers, vehicle service payers, vehicle warranty providers, vehicle managers, vehicle maintenance managers, described herein.

Each of the central processing computer(s), the user computer(s) or communication device(s), the vehicle computer(s) or communication device(s), the vehicle dealer computer(s) or communication device(s), the vehicle manufacturer computer(s) or communication device(s), the vehicle service provider computers or communication device(s), the vehicle parts provider computers or communication device(s), the service payer computer(s) or communication device(s), the vehicle insurance provider computer(s) or communication device(s), and/or the intermediary computer(s) or communication device(s), can transmit information to, as well as receive information from, any of the central processing computer(s), the user computer(s) or communication device(s), the vehicle computer(s) or communication device(s), the vehicle dealer computer(s) or communication device(s), the vehicle manufacturer computer(s) or communication device(s), the vehicle service provider computer(s) or communication device(s), the vehicle parts provider computer(s) or communication device(s), the service payer computer(s) or communication device(s), the vehicle insurance provider computer(s) or communication device(s), and/or the intermediary computer(s) or communication device(s), described herein.

Each of the central processing computer(s), the user computer(s) or communication device(s), the vehicle computer(s) or communication device(s), the vehicle dealer computer(s) or communication device(s), the vehicle manufacturer computer(s) or communication device(s), the vehicle service provider computer(s) or communication device(s), the vehicle parts provider computer(s) or communication device(s), the service payer computer(s) or communication device(s), the vehicle insurance provider computer(s) or communication device(s), and/or the intermediary computer(s) or communication device(s), can include any hardware, peripheral devices, software, and/or data and/or information, needed and/or desired for performing any and/or all of the processing routines and/or functions described herein as being performed by each of the respective computers or communication devices.

The central processing computer(s), the user computer(s) or communication device(s), the vehicle computer(s) or communication device(s), the vehicle dealer computer(s) or communication device(s), the vehicle manufacturer computer(s) or communication device(s), the vehicle service provider computer(s) or communication device(s), the vehicle parts provider computer(s) or communication device(s), the service payer computer(s) or communication device(s), the vehicle insurance provider computer(s) or communication device(s), and/or the intermediary computer(s) or communication device(s), can communicate with one another, and/or can be linked to one another, over a communication network, a telecommunication network, a telephone network, a line-connected network, and/or a wireless communication network.

Each of the computer or communication devices can be linked with any other computer or communication device or computer or communication devices directly or indirectly directly or indirectly with one another so as to facilitate a direct or indirect bi-directional communication any of said respective computer or communication devices.

The present invention is can be utilized on, and/or over, any suitable communication network or system. The present invention can also be utilized in conjunction with a wireless communication network or system.

The apparatus of the present invention can utilize electronic commerce technologies and security methods, techniques and technologies, in any and/or all of the instances of data and/or information processing, and/or data and/or information transmission described herein.

The apparatus and method of the present invention can be utilized in numerous preferred embodiments in order to provide a vast array of vehicle maintenance services, vehicle repair services, vehicle servicing services, and/or any other vehicle-related services, for any one or more of the various parties described herein.

The present invention can be utilized to create and maintain comprehensive vehicle databases which can be accessed via a network environment and/or otherwise, to perform vehicle maintenance services, vehicle repair services, vehicle servicing services, to obtain vehicle information, to obtain vehicle-related information, and/or to provide any other information, services, functions and/or functionality, described herein.

The present invention can also be utilized in order to provide training and continuing education services for vehicle owners, operators, users, vehicle dealers, vehicle manufacturers, vehicle service providers, vehicle parts providers, service payers, vehicle insurance providers, and/or intermediaries, to provide information about vehicles, vehicle maintenance, vehicle repair, vehicle servicing, and/or any other vehicle-related information, to provide vehicle maintenance, vehicle repair, vehicle servicing, scheduling management services, for any of the herein-described parties.

The present invention can also be utilized in order to provide notification services for any of the owners, operators, users, vehicle dealers, vehicle manufacturers, vehicle service providers, vehicle parts providers, service payers, vehicle insurance providers, and/or intermediaries, described herein, and/or to locate owners, operators, users, vehicle dealers, vehicle manufacturers, vehicle service providers, vehicle parts providers, service payers, vehicle insurance providers, and/or intermediaries, for any of the parties described herein.

The present invention can also be utilized as a clearinghouse for facilitating the offering, selling, buying, trading, and/or other commerce and/or transactions, involving vehicles, vehicle maintenance, vehicle repairs, vehicle servicing, vehicle sales, vehicle insurance, and/or any other vehicle-related goods, products, and/or services.

The present invention can be utilized in order to perform a diagnosis of a vehicle problem, malfunction, and/or state of disrepair. The present invention can also be utilized in order to ascertain a diagnosis and/or in order to check on, verify, and/or ascertain the correctness of a diagnosis of another. The present invention can also be utilized to prescribe a respective repair, maintenance, and/or servicing, procedures for the diagnosis and/or for the possible diagnoses.

The present invention can also process vehicle information in conjunction with any one or more of information regarding the cost of the respective repair(s), maintenance, and/or servicing, procedures, the cost of parts, components, equipment, and/or accessories, the maintenance and/or histories, including success rates for similar repairs, maintenance, and/or servicing, procedures for the same or similar vehicles, and/or the value of the vehicle, in order to ascertain the feasibility of performing the repair, the maintenance procedure, and/or the servicing procedure, for the vehicle.

The present invention can also process vehicle information in conjunction with the various dealers, service providers, repair facilities, parts providers, accessory providers, equipment providers, warranty providers, service payers, and/or insurance providers, who or which can effect the respective repair, maintenance, and/or servicing, procedure, provide the respective part(s), equipment, component, and/or accessory, and/or can be responsible for paying for the respective repair, maintenance, and/or servicing, procedure, part(s), equipment, component, and/or accessory.

Data and/or information regarding the vehicle can be uploaded from the vehicle computer or communication device to the central processing computer or communication device via the communication network. In this manner, the present invention can be utilized so as to perform vehicle diagnostic services by obtaining data and/or information from the vehicle computer or communication device and/or from a vehicle command computer or communication device.

The present invention can also be utilized in order to perform periodic diagnostic checks for a vehicle and/or in order to perform the monitoring of vehicle functions for or regarding any vehicle and/or at any pre-defined interval.

The apparatus and method of the present invention can be utilized in order to provide scheduled maintenance and/or scheduled service reminders to any of the herein-described users, vehicle owners and/or vehicle operators.

The present invention can also transmit diagnostic reports, repair reports, maintenance reports, regarding the diagnoses, repairs, maintenance procedures, and/or servicing procedures, which are performed for, on, and/or in conjunction with, any of the vehicles which are serviced by the apparatus of the present invention apparatus to any of the respective vehicle manufacturers, vehicle dealers, vehicle service providers, vehicle repair facilities, vehicle parts providers, vehicle equipment providers, vehicle component providers, vehicle insurance providers, vehicle warranty providers, and/or vehicle service payers, as well as any consumer reporting entities, such as, but not limited to, and/or consumer reporting services.

The apparatus and method of the present invention can transmit diagnostic reports, repair reports, maintenance reports, regarding the diagnoses, repairs, maintenance procedures, and/or servicing procedures, which are performed for, on, and/or in conjunction with, any of the vehicles which are serviced by the apparatus of the present invention to any of the users, vehicle owners, vehicle operators, and/or fleet managers, who or which may utilize the apparatus and method of the present invention.

The present invention can also be utilized in order to provide repair, maintenance, and/or servicing instructions, instructional materials, video materials, audio materials, audio/visual materials, and/or any other information and/or materials for providing information regarding the vehicle problem, malfunction and/or state of disrepair, and/or the repair procedures, the maintenance procedures, and/or the servicing procedures, which are related to, and/or which are recommended for effectuating and performing, the respective vehicle problem, malfunction and/or state of disrepair, in conjunction with any diagnostic report, and/or any of the repair, maintenance, and/or servicing, report(s), which can be provided by the apparatus and method of the present invention.

The present invention can also be utilized in order to provide statistical information regarding past successful repairs, maintenance, and/or servicing, past unsuccessful repairs, maintenance, and/or servicing, the cost(s) of the repairs, maintenance, and/or servicing, vehicle values, and the feasibility, economic, mechanical, and/or otherwise, or performing the repair, maintenance, and/or servicing, on a vehicle.

The apparatus and method of the present invention can be utilized to ensure that a proper repair, maintenance procedure, and/or servicing procedure, is performed on the vehicle, and/or that the correct part(s), equipment(s), component(s), accessory, and/or accessories, is or are obtained.

The present invention can also provide also information regarding repair instructions, maintenance procedures, and/or servicing procedures, and/or information regarding part(s), along information regarding the appropriateness and/or inappropriateness of same for a given vehicle repair procedure, maintenance procedure and/or servicing procedure.

In another preferred embodiment, the present invention can be utilized to perform the monitoring of vehicle maintenance, vehicle repair, and/or vehicle servicing. The present invention can also be utilized in order to evaluate and/or to monitor repairs, maintenance procedures, servicing procedures, and/or parts, equipment, components, and/or accessories, utilized, for a vehicle or vehicles, in order to evaluate repairs, maintenance procedures, servicing procedures, and/or maintenance programs, and/or costs regarding same.

The present invention can also be utilized for instructional purposes and/or for evaluating, instituting, and/or modifying, vehicle repair programs, maintenance programs, and/or servicing programs. The present invention can also be utilized in order to safeguard against the use of incorrect, unconventional, and/or fraudulent, repairs, maintenance procedures, servicing procedures.

The present invention can be utilized to identify and/or to locate manufacturers, dealers, service providers, repair facilities, service technicians, mechanics, parts, parts providers, equipment, equipment providers, components, components providers, accessories, and/or accessories providers.

The apparatus and method of the present invention can also be utilized to identify users, owners, and/or operators, who or which may be in need and/or require repairs, maintenance procedures, servicing procedures, parts, equipment, components, and/or accessories.

The present invention can also be utilized by any user, owner or operator, can utilize the present invention in order to locate a dealer, a service provider, a service technician, a mechanic, a specialist, a specialized facility, a parts provider, an equipment provider, a component provider, and/or an accessory provider.

The present invention can also be utilized to provide scheduling services for, and/or on behalf of, any of the dealers, service providers, repair facilities, service technicians, mechanics, described herein. The present invention can maintain work schedules, and/or scheduling data and/or information, of and for any of the dealers, service providers, repair facilities, service technicians, mechanics, described herein. Any user, owner, or operator, can utilize the schedules and/or scheduling data and/or information in order to reserve, engage, and/or request, the services of a dealer, service provider, service technician, or mechanic.

The present invention can be programmed to confirm a reservation, agree to an engagement, and/or issue a reply, respectively, for, or on behalf, of a dealer(s), a service provider(s), a service technician(s), and/or a mechanic(s) The present invention can also be programmed to provide a user, owner, or operator, with conditions under which dealer(s), service provider(s), service technician(s), or mechanic(s), will agree to a reservation, an engagement, and/or a request.

The apparatus and method of the present can also be utilized as a vehicle repair, maintenance and/or servicing, training simulator for any of the manufacturers, dealers, service providers service technicians, and/or mechanics, described herein. The present invention can also be utilized by any user, owner, or operator, desiring to learn about a certain vehicle repair, vehicle maintenance, and/or vehicle servicing, topic. The present invention can be utilized to provide formal training, supplemental training, informal training, continuing education training, and/or any other training, to any respective individual.

The present invention can be utilized to facilitate vehicle repair claims processing.

The apparatus and method of the present invention can be utilized to provide for the bidding for, and/or the auctioning off of, any of the herein-described vehicle repair services, vehicle maintenance services, vehicle servicing services, vehicle parts, vehicle equipment, vehicle components, vehicle accessories, vehicle insurance policies, vehicle warranties, vehicle extended warranties, and/or any other vehicle and/or vehicle-related services, goods, and/or products, by any of the respective users, vehicle owners, vehicle operators, vehicle managers, manufacturers, dealers, service providers, parts providers, equipment providers, component providers, accessory providers, insurance providers, and/or service payers.

The apparatus and method of the present invention can also be utilized to provide for the bidding for, and/or the auctioning off of, the business or patronage of any of the users, vehicle owners, vehicle operators, vehicle managers, manufacturers, dealers, service providers, parts providers, equipment providers, component providers, accessory providers, insurance providers, and/or service payers.

The present invention can also generate electronic catalogs and/or electronic coupons for use by any of the respective vehicle manufacturers, vehicle dealers, vehicle service providers, vehicle parts providers, vehicle insurers, vehicle insurance providers, vehicle service payers, vehicle warranty providers, vehicle managers, vehicle maintenance managers, and/or any agents, brokers, and/or intermediaries, to publicize and/or to advertise their respective vehicles, vehicle pair services, vehicle maintenance services, vehicle servicing services, vehicles parts, vehicle equipment, vehicle components, and/or vehicle accessories. The electronic catalogs can be utilized to publicize and/or advertise regular offerings, special offerings, and/or sale offerings.

The present invention can be utilized in order to generate and disseminate electronic catalogs and/or electronic coupons.

Any and/or all of the data and/or information described herein can be compiled and processed using statistical calculations in order to update the stored data and/or information with such data and/or information being made available to the respective users, owners, operators, manufacturers, dealers, service providers, repair facilities, service technicians, mechanics, parts providers, equipment providers, component providers, and/or accessory providers, who or which utilize the present invention.

The present invention can also be utilized in conjunction with intelligent agents, software agents, mobile agents, and/or related technologies. The apparatus of the present invention, in any and/or all of the embodiments described herein, can also be programmed to be self-activating and/or activated automatically.

The apparatus of the present invention can also be programmed in order to automatically generate and/or transmit any of the e-mails, electronic message transmissions, electronic notification transmissions, electronic catalogs, electronic coupons, and/or any of the communications, which are described herein, between any of the parties which utilize the present invention.

The present invention can also be utilized in order to administer and/or maintain a financial account(s) for, or on behalf of any of, any of the users, owners, or operators, dealers, manufacturers, service providers, service technicians, or mechanics, insurance providers, service payers, and/or intermediaries, who or which utilize the apparatus and method of the present invention.

The present invention can also be utilized in order to make a payment and/or a monetary transfer for, or receive a payment for, on behalf of, any of the users, owners, or operators, dealers, service providers, service technicians, mechanics, insurance providers, service payers, and/or intermediaries, who or which utilize the present invention.

The present invention can utilize electronic commerce technologies and security methods, techniques and technologies.

The present invention can also be utilized in conjunction with the buying, selling, bartering, and/or trading, of any of the repair services, maintenance services, servicing services, parts, equipment, components, and/or accessories, insurance policies, warranties, described herein, by and/or between any of the users, owners, operators, manufacturers, dealers, service providers, repair facilities, service technicians, mechanics, parts providers, equipment providers, component providers, and/or accessory providers, insurance providers, service payers, and/or intermediaries, described herein.

The present invention can also be utilized in order to monitor and/or be record any interactions, negotiations, and/or deals reached, between any of the parties who or which utilize the present invention.

The present invention can also be utilized for processing and/or for providing equipment information and/or industrial equipment maintenance information which facilitates the distribution and management of maintenance information, servicing information, as well as the any other industrial equipment information and/or industrial equipment-related information.

Accordingly, it is an object of the present invention to provide an apparatus and a method for processing and/or for providing vehicle information and/or vehicle maintenance information.

It is another object of the present invention to provide an apparatus and a method for processing and/or for providing vehicle information and/or vehicle maintenance information, in a network environment.

It is still another object of the present invention to provide an apparatus and a method for processing and/or for providing vehicle information and/or vehicle maintenance information for a variety of vehicle maintenance, vehicle servicing, and vehicle-related applications.

It is yet another object of the present invention to provide an apparatus and a method for processing and/or for providing vehicle information and/or vehicle maintenance information which facilitates the creation and management of a comprehensive vehicle database and maintenance processing system.

It is another object of the present invention to provide an apparatus and a method for processing and/or for providing vehicle information and/or vehicle maintenance information which facilitates improved vehicle maintenance, improved vehicle maintenance quality, improved vehicle maintenance record-keeping, efficient vehicle information collection, processing and dissemination, efficient vehicle diagnosis and servicing, cost efficiency, cost containment, as well as many other benefits and advantages.

It is still another object of the present invention to provide an apparatus and a method for processing and/or for providing vehicle information and/or vehicle maintenance information which facilitates the distribution and management of vehicle maintenance information, vehicle servicing information, as well as the any other vehicle information and/or vehicle-related information.

It is yet another object of the present invention to provide an apparatus and a method for processing and/or for providing vehicle information and/or vehicle maintenance information which can be utilized by any users, vehicle owners, vehicle operators, vehicle manufacturers, vehicle dealers, vehicle service providers, vehicle parts providers, vehicle insurers, vehicle insurance providers, vehicle service payers, vehicle warranty providers, vehicle managers, vehicle maintenance managers, and/or any agents, brokers, and/or intermediaries and/or third parties who or which acts on behalf of another.

It is another object of the present invention to provide an apparatus and a method for processing and/or for providing vehicle information and/or vehicle maintenance information which can be utilized in conjunction with any suitable computer(s) or communication device(s).

It is still another object of the present invention to provide an apparatus and a method for processing and/or for providing vehicle information and/or vehicle maintenance information which can be utilized on, over, and/or in conjunction with, any suitable communication network or system.

It is yet another object of the present invention to provide an apparatus and a method for processing and/or for providing vehicle information and/or vehicle maintenance information which can be utilized on, over, and/or in conjunction with, the Internet and/or the World Wide Web.

It is another object of the present invention to provide an apparatus and a method for processing and/or for providing vehicle information and/or vehicle maintenance information which can be utilized on, over, and/or in conjunction with, a wireless communication network or system and/or wireless communication devices.

It is still another object of the present invention to provide an apparatus and a method for processing and/or for providing vehicle information and/or vehicle maintenance information which can utilize TCP/IP, as well as any other Internet and/or World Wide Web, and/or communication, protocols.

It is yet another object of the present invention to provide an apparatus and a method for processing and/or for providing vehicle information and/or vehicle maintenance information which can be utilized to provide information and/or services for or regarding any one or more or vehicle users, vehicle owners, vehicle operators, vehicles, vehicle dealers, vehicle manufacturers, vehicle service providers, vehicle parts providers, service payers, vehicle insurance providers, and/or intermediaries.

It is another object of the present invention to provide an apparatus and a method for processing and/or for providing vehicle information and/or vehicle maintenance information, which can be utilized to create and maintain comprehensive vehicle database(s) which can be accessed via a network environment.

It is still another object of the present invention to provide an apparatus and a method for processing and/or for providing vehicle information and/or vehicle maintenance information which can be utilized in order to provide notification services for any of the owners, operators, users, vehicle dealers, vehicle manufacturers, vehicle service providers, vehicle parts providers, service payers, vehicle insurance providers, and/or intermediaries.

It is yet another object of the present invention to provide an apparatus and a method for processing and/or for providing vehicle information and/or vehicle maintenance information which can be utilized to identify and/or to locate of owners, operators, users, vehicle dealers, vehicle manufacturers, vehicle service providers, vehicle parts providers, service payers, vehicle insurance providers, and/or intermediaries, for any of the parties described herein.

It is another object of the present invention to provide an apparatus and a method for processing and/or for providing vehicle information and/or vehicle maintenance information which can be utilized as a clearinghouse for facilitating the offering, selling, buying, trading, and/or other commerce and/or transactions, involving vehicles, vehicle maintenance, vehicle repairs, vehicle servicing, vehicle sales, vehicle insurance, and/or any other vehicle-related goods, products, and/or services.

It is still another object of the present invention to provide an apparatus and a method for processing and/or for providing vehicle information and/or vehicle maintenance information which can be utilized in order to perform a diagnosis of a vehicle problem, malfunction, and/or state of disrepair.

It is yet another object of the present invention to provide an apparatus and a method for processing and/or for providing vehicle information and/or vehicle maintenance information which can be utilized in order to ascertain a diagnosis and/or in order to check on, verify, and/or ascertain the correctness of a diagnosis of another.

It is another object of the present invention to provide an apparatus and a method for processing and/or for providing vehicle information and/or vehicle maintenance information which can be utilized to prescribe a respective repair, maintenance, and/or servicing, procedures for the diagnosis and/or for the possible diagnoses.

It is still another object of the present invention to provide an apparatus and a method for processing and/or for providing vehicle information and/or vehicle maintenance information which can be utilized to process information regarding the cost of the respective repair(s), maintenance, and/or servicing, procedures, the cost of parts, components, equipment, and/or accessories, the maintenance and/or histories, including success rates for similar repairs, maintenance, and/or servicing, procedures for the same or similar vehicles, and/or the value of the vehicle, in order to ascertain the feasibility of performing the repair, the maintenance procedure, and/or the servicing procedure, for the vehicle.

It is yet another object of the present invention to provide an apparatus and a method for processing and/or for providing vehicle information and/or vehicle maintenance information which can be utilized to process vehicle information in conjunction with the various dealers, service providers, repair facilities, parts providers, accessory providers, equipment providers, warranty providers, service payers, and/or insurance providers, who or which can effect the respective repair, maintenance, and/or servicing, procedure, provide the respective part(s), equipment, component, and/or accessory, and/or can be responsible for paying for the respective repair, maintenance, and/or servicing, procedure, part(s), equipment, component, and/or accessory.

It is another object of the present invention to provide an apparatus and a method for processing and/or for providing vehicle information and/or vehicle maintenance information which can be utilized to upload and/or obtain data and/or information regarding the vehicle to the central processing computer or communication device via the communication network for performing vehicle diagnostics, repair, maintenance and/or servicing.

It is still another object of the present invention to provide an apparatus and a method for processing and/or for providing vehicle information and/or vehicle maintenance information which can be utilized to upload and/or obtain data and/or information regarding the vehicle to the central processing computer or communication device via the communication network for performing vehicle diagnostics, repair, maintenance and/or servicing, form a remote location.

It is yet another object of the present invention to provide an apparatus and a method for processing and/or for providing vehicle information and/or vehicle maintenance information which can be utilized in order to perform periodic diagnostic checks for a vehicle and/or in order to perform the monitoring of vehicle functions for or regarding any vehicle and/or at any pre-defined interval.

It is another object of the present invention to provide an apparatus and a method for processing and/or for providing vehicle information and/or vehicle maintenance information which can be utilized in order to provide scheduled maintenance and/or scheduled service reminders to users, vehicle owners and/or vehicle operators.

It is still another object of the present invention to provide an apparatus and a method for processing and/or for providing vehicle information and/or vehicle maintenance information which can be utilized to generate and transmit any one or more of diagnostic reports, repair reports, maintenance reports, regarding the diagnoses, repairs, maintenance procedures, and/or servicing procedures, for or regarding a vehicle or vehicles.

It is yet another object of the present invention to provide an apparatus and a method for processing and/or for providing vehicle information and/or vehicle maintenance information which can be utilized in order to provide repair, maintenance, and/or servicing instructions, instructional materials, video materials, audio materials, audio/visual materials, and/or any other information and/or materials for or regarding vehicles, repair procedures, the maintenance procedures, and/or the servicing procedures.

It is another object of the present invention to provide an apparatus and a method for processing and/or for providing vehicle information and/or vehicle maintenance information which can be utilized in order to provide statistical information regarding past successful repairs, maintenance, and/or servicing, past unsuccessful repairs, maintenance, and/or servicing, the cost(s) of the repairs, maintenance, and/or servicing, vehicle values, and the feasibility, economic, mechanical, and/or otherwise, or performing the repair, maintenance, and/or servicing, on a vehicle.

It is still another object of the present invention to provide an apparatus and a method for processing and/or for providing vehicle information and/or vehicle maintenance information which can be utilized to ensure that a proper repair, maintenance procedure, and/or servicing procedure, is performed on the vehicle, and/or that the correct part(s), equipment(s), component(s), accessory, and/or accessories, is or are obtained.

It is yet another object of the present invention to provide an apparatus and a method for processing and/or for providing vehicle information and/or vehicle maintenance information which can be utilized in order to provide information regarding repair instructions, maintenance procedures, and/or servicing procedures, and/or information regarding part(s), along information regarding the appropriateness and/or inappropriateness of same for a given vehicle repair procedure, maintenance procedure and/or servicing procedure.

It is another object of the present invention to provide an apparatus and a method for processing and/or for providing vehicle information and/or vehicle maintenance information which can be utilized to perform the monitoring of vehicle maintenance, vehicle repair, and/or vehicle servicing.

It is still another object of the present invention to provide an apparatus and a method for processing and/or for providing vehicle information and/or vehicle maintenance information which can be utilized in order to evaluate and/or to monitor repairs, maintenance procedures, servicing procedures, and/or parts, equipment, components, and/or accessories, utilized, for a vehicle or vehicles.

It is yet another object of the present invention to provide an apparatus and a method for processing and/or for providing vehicle information and/or vehicle maintenance information which can be utilized to evaluate, institute, and/or modify, vehicle repair programs, maintenance programs, and/or servicing programs.

It is another object of the present invention to provide an apparatus and a method for processing and/or for providing vehicle information and/or vehicle maintenance information which can be utilized in order to safeguard against the use of incorrect, unconventional, and/or fraudulent, repairs, maintenance procedures, servicing procedures.

It is still another object of the present invention to provide an apparatus and a method for processing and/or for providing vehicle information and/or vehicle maintenance information which can be utilized to identify and/or to locate manufacturers, dealers, service providers, repair facilities, service technicians, mechanics, parts, parts providers, equipment, equipment providers, components, components providers, accessories, and/or accessories providers.

It is yet another object of the present invention to provide an apparatus and a method for processing and/or for providing vehicle information and/or vehicle maintenance information which can be utilized to identify and/or locate users, owners, and/or operators, who or which may be in need and/or require repairs, maintenance procedures, servicing procedures, parts, equipment, components, and/or accessories.

It is another object of the present invention to provide an apparatus and a method for processing and/or for providing vehicle information and/or vehicle maintenance information which can be utilized in order to locate a dealer, a service provider, a service technician, a mechanic, a specialist, a specialized facility, a parts provider, an equipment provider, a component provider, and/or an accessory provider.

It is still another object of the present invention to provide an apparatus and a method for processing and/or for providing vehicle information and/or vehicle maintenance information which can be utilized to provide scheduling services for, and/or on behalf of, any of the dealers, service providers, repair facilities, service technicians, mechanics, described herein.

It is yet another object of the present invention to provide an apparatus and a method for processing and/or for providing vehicle information and/or vehicle maintenance information which can be utilized in order to maintain work schedules, and/or scheduling data and/or information, of and for dealers, service providers, repair facilities, service technicians, mechanics.

It is another object of the present invention to provide an apparatus and a method for processing and/or for providing vehicle information and/or vehicle maintenance information which can be utilized in order to reserve, engage, and/or request, the services of a dealer, service provider, service technician, and/or mechanic.

It is still another object of the present invention to provide an apparatus and a method for processing and/or for providing vehicle information and/or vehicle maintenance information which can be utilized to confirm a reservation, agree to an engagement, and/or issue a reply, respectively, for, or on behalf, of a dealer(s), a service provider(s), a service technician(s), and/or a mechanic(s).

It is yet another object of the present invention to provide an apparatus and a method for processing and/or for providing vehicle information and/or vehicle maintenance information which can be utilized as a vehicle repair, maintenance and/or servicing, training simulator and/or educational services provider regarding vehicles, vehicle repair, vehicle maintenance, and/or vehicle servicing.

It is another object of the present invention to provide an apparatus and a method for processing and/or for providing vehicle information and/or vehicle maintenance information which can be utilized to facilitate vehicle repair claims processing.

It is still another object of the present invention to provide an apparatus and a method for processing and/or for providing vehicle information and/or vehicle maintenance information which can be utilized to provide for the bidding for, and/or the auctioning off of, vehicle repair services, vehicle maintenance services, vehicle servicing services, vehicle parts, vehicle equipment, vehicle components, vehicle accessories, vehicle insurance policies, vehicle warranties, vehicle extended warranties, and/or vehicle and/or vehicle-related services, goods, and/or products.

It is yet another object of the present invention to provide an apparatus and a method for processing and/or for providing vehicle information and/or vehicle maintenance information which can be utilized to provide for the bidding for, and/or the auctioning off of, the business or patronage of any of the users, vehicle owners, vehicle operators, vehicle managers, manufacturers, dealers, service providers, parts providers, equipment providers, component providers, accessory providers, insurance providers, and/or service payers.

It is another object of the present invention to provide an apparatus and a method for processing and/or for providing vehicle information and/or vehicle maintenance information which can be utilized in order to generate electronic catalogs and/or electronic coupons.

It is still another object of the present invention to provide an apparatus and a method for processing and/or for providing vehicle information and/or vehicle maintenance information which can be utilized in order to generate electronic catalogs and/or electronic coupons to publicize and/or to advertise vehicles, vehicle pair services, vehicle maintenance services, vehicle servicing services, vehicles parts, vehicle equipment, vehicle components, and/or vehicle accessories.

It is yet another object of the present invention to provide an apparatus and a method for processing and/or for providing vehicle information and/or vehicle maintenance information which can be utilized in order to generate and disseminate electronic catalogs and/or electronic coupons.

It is another object of the present invention to provide an apparatus and a method for processing and/or for providing vehicle information and/or vehicle maintenance information which can utilize intelligent agents, software agents, mobile agents, and/or related technologies.

It is still another object of the present invention to provide an apparatus and a method for processing and/or for providing vehicle information and/or vehicle maintenance information which can be programmed to be self-activating and/or activated automatically.

It is yet another object of the present invention to provide an apparatus and a method for processing and/or for providing vehicle information and/or vehicle maintenance information which can be utilized in order to administer and/or to maintain financial accounts for, or on behalf of, users, owners, or operators, dealers, manufacturers, service providers, service technicians, or mechanics, insurance providers, service payers, and/or intermediaries who or which utilize the present invention.

It is another object of the present invention to provide an apparatus and a method for processing and/or for providing vehicle information and/or vehicle maintenance information which can be utilized in order to make a payment and/or a monetary transfer for, or receive a payment for, on behalf of, any users, owners, or operators, dealers, service providers, service technicians, mechanics, insurance providers, service payers, and/or intermediaries, who or which utilize the present invention.

It is still another object of the present invention to provide an apparatus and a method for processing and/or for providing vehicle information and/or vehicle maintenance information which can be utilized in conjunction with electronic commerce technologies and security methods, techniques and technologies.

It is yet another object of the present invention to provide an apparatus and a method for processing and/or for providing vehicle information and/or vehicle maintenance information which can be utilized in conjunction with the buying, selling, bartering, and/or trading, of repair services, maintenance services, servicing services, parts, equipment, components, and/or accessories, insurance policies, and/or vehicle warranties.

It is another object of the present invention to provide an apparatus and a method for processing and/or for providing vehicle information and/or vehicle maintenance information which can be utilized in order to monitor and/or record interactions, negotiations, and/or deals reached, between any of the parties who or which utilize the present invention.

It is still another object of the present invention to provide an apparatus and a method for processing and/or for providing vehicle information and/or vehicle maintenance information which can utilize electronic commerce technologies and security methods, techniques and technologies.

It is yet another object of the present invention to provide an apparatus and a method for processing and/or for providing equipment information and/or industrial equipment maintenance information which facilitates the distribution and management of maintenance information, servicing information, as well as the any other industrial equipment information and/or industrial equipment-related information.

Other objects and advantages of the present invention will be apparent to those skilled in the art upon a review of the Description of the Preferred Embodiments taken in conjunction with the Drawings which follow.

### BRIEF DESCRIPTION OF THE DRAWINGS

In the Drawings:

FIG. 1 illustrates a preferred embodiment of the present invention, in block diagram form;

FIG. 2 illustrates the central processing computer of FIG. 1, in block diagram form;

FIG. 3 illustrates the user computer device of FIG. 1, in block diagram form;

FIG. 4 illustrates the vehicle computer of FIG. 1, in block diagram form;

FIG. 5 illustrates the vehicle dealer computer of FIG. 1, in block diagram form;

FIG. 6 illustrates the vehicle manufacturer computer of FIG. 1, in block diagram form;

FIG. 7 illustrates the service provider computer of FIG. 1, in block diagram form;

FIG. 8 illustrates the parts provider computer of FIG. 1, in block diagram form;

FIG. 9 illustrates the insurance provider computer FIG. 1, in block diagram form;

FIG. 10 illustrates the service payer computer of FIG. 1, in block diagram form;

FIG. 11 illustrates the intermediary computer of FIG. 1, in block diagram form;

FIGS. 12A, 12B and 12C illustrate a preferred embodiment method of using the present invention, in flow diagram form;

FIG. 13 illustrates still another preferred embodiment method of using the present invention, in flow diagram form;

FIG. 14 illustrates yet another preferred embodiment method of using the present invention, in flow diagram form;

FIG. 15 illustrates another preferred embodiment method of using the present invention, in flow diagram form;

FIGS. 16A and 16B illustrate still another preferred embodiment method of using the present invention, in flow diagram form; and

FIGS. 17A and 17B illustrate yet another preferred embodiment method of using the present invention, in flow diagram form.

### DESCRIPTION OF THE PREFERRED EMBODIMENTS

The present invention is directed to an apparatus and a method for processing and/or for providing vehicle information and/or vehicle maintenance information and, in particular, to an apparatus and a method for processing and/or for providing vehicle information and/or vehicle maintenance information for a variety of vehicle maintenance, vehicle servicing, and vehicle-related applications.

The apparatus and method of the present invention facilitates the creation and management of a comprehensive vehicle maintenance processing system which can manage vehicle information and/or records, vehicle maintenance information and/or records, vehicle owner and/or operator information and/or records, vehicle service information and/or records, vehicle dealer information and/or records, service provider information and/or records, vehicle parts provider information and/or records, vehicle manufacturer information and/or records, and/or vehicle service payer information and/or records.

The present invention facilitates improved vehicle maintenance, improved vehicle maintenance quality, improved vehicle maintenance record-keeping, efficient vehicle information collection, processing and dissemination, efficient vehicle diagnosis and servicing, cost efficiency, cost containment, as well as many other benefits and advantages as will be described herein.

The apparatus and method of the present invention also facilitates the distribution and management of vehicle maintenance information, vehicle servicing information, as well as the any other vehicle information and/or vehicle-related information.

The present invention also provides an apparatus and a method for providing a comprehensive database of, and processing system for, data and/or information for or from any combination of vehicles and/or participants in the vehicle maintenance and/or vehicle servicing fields, including, but not limited to, users, vehicle owners, vehicle operators, vehicle manufacturers, vehicle dealers, vehicle service providers, vehicle parts providers, vehicle insurers, vehicle insurance providers, vehicle service payers, vehicle warranty providers, vehicle managers, vehicle maintenance managers, and/or any agents, brokers, and/or intermediaries and/or third parties, who or which acts on behalf of another and/or assists in to providing vehicle, vehicle maintenance, and/or related services.

The term “vehicle” or “vehicles”, as utilized herein, refer to any vehicles, motor vehicles, automobiles, cars, trucks, buses, equipment, construction equipment, industrial equipment, private vehicles, commercial vehicles, marine vehicles, boats, motorboats, sailboats, aircraft, jets, airplanes, planes, space travel vehicles, satellites, and/or spacecraft, including private, personal, commercial, and/or industrial, vehicles, motor vehicles, automobiles, cars, trucks, buses, equipment, construction equipment, industrial equipment, private vehicles, commercial vehicles, marine vehicles, boats, motorboats, sailboats, aircraft, jets, airplanes, planes, space travel vehicles, satellites, and/or spacecraft, as well as manned and/or unmanned vehicles, motor vehicles, automobiles, cars, trucks, buses, equipment, construction equipment, industrial equipment, including equipment which are located at premises of any kind or type (such as for example drilling rigs and other industrial equipment), private vehicles, commercial vehicles, marine vehicles, boats, motorboats, sailboats, aircraft, jets, airplanes, planes, space travel vehicles, satellites, and/or spacecraft.

Applicant hereby incorporates by reference herein the subject matter and teachings of U.S. Provisional Patent Application Ser. No. 60/222,623 which teaches and discloses an apparatus and method for processing and/or for providing vehicle information and/or vehicle maintenance information.

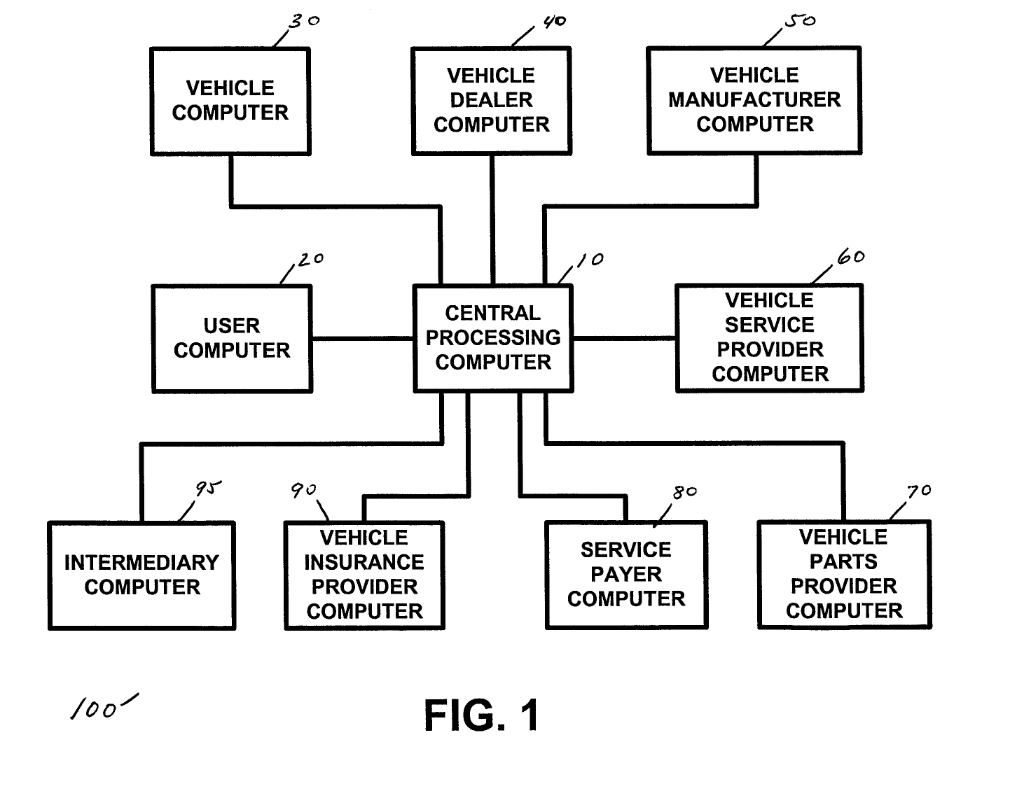

FIG. 1 illustrates the apparatus of the present invention, in block diagram form. The apparatus of the present invention is denoted generally by the reference numeral 100. In the preferred embodiment, the apparatus 100 of the present invention includes a central processing computer or central processing computer system 10 (hereinafter referred to as the “central processing computer 10”). In the preferred embodiment, the central processing computer 10 can be a network or server computer.

In the preferred embodiment, the central processing computer can provide control over the apparatus 100 and can perform any of the various processing services and/or functions described herein. The central processing computer 10 may be a single computer or system of computers and/or may be include a plurality of computers or computer systems which are utilized in conjunction with one another.

The central processing computer 10, in the preferred embodiment can provides services for any of the other computers and/or computer systems described herein as being associated with any of the users, vehicle owners, vehicle operators, vehicle manufacturers, vehicle dealers, vehicle service providers, vehicle parts providers, vehicle insurers, vehicle insurance providers, vehicle service payers, vehicle warranty providers, vehicle managers, vehicle maintenance managers, and/or any agents, brokers, and/or intermediaries and/or third parties, who or which acts on behalf of another.

The apparatus 100 also includes a user communication device or computer 20 (hereinafter referred to as “user computer 20”) which is associated with a user of the apparatus and method of the present invention, a vehicle owner, a vehicle user, and/or any other individual who or which utilizes the apparatus and method of the present invention and/or any of the services described herein. Any number or amount of user computers 20 can be utilized in conjunction with a user or individual. The user computer(s) 20 can communicate with, and operate in conjunction with, the central processing computer 10 and/or any of the other computers and/or computer systems associated with any of the other individuals and/or entities who or which utilize the present invention.

A user computer 20 may also be located at public places or locations, such as at kiosks or other publicly available computer or communication devices. Any number or amount of user computers 10 can be utilized in conjunction with a user and/or group of users.

The apparatus 100 also includes a vehicle computer 30 (hereinafter referred to as “vehicle computer 30”) which is associated with any of the vehicles described herein. Any number or amount of vehicle computers 30 can be utilized in conjunction with the present invention. The vehicle computer(s) 30 can communicate with, and operate in conjunction with, central processing computer 10 and/or any of the other computers and/or computer systems associated with any of the other individuals and/or entities who or which utilize and/or operate in conjunction with the present invention.

The apparatus 100 also includes a vehicle dealer communication device or computer 40 (hereinafter “vehicle dealer computer 40”) which is associated with a vehicle dealer who or which utilizes the apparatus and method of the present invention to obtain or utilize vehicle information, vehicle maintenance information and/or vehicle-related information. The vehicle dealer computer(s) 40 can communicate with, and operate in conjunction with, the central processing computer 10 and/or any of the other computers and/or computer systems associated with any of the other individuals and/or entities which utilize and/or operate in conjunction with the present invention.

The apparatus 100 also includes a vehicle manufacturer communication device or computer 50 (hereinafter “vehicle manufacturer computer 50”) which is associated with a vehicle manufacturer, who or which utilizes the apparatus and method of the present invention to obtain or utilize vehicle information, vehicle maintenance information and/or vehicle-related information. The vehicle manufacturer computer(s) 50 can communicate with, and operate in conjunction with, the central processing computer 10 and/or any of the other computers and/or computer systems associated with any of the other individuals and/or entities which utilize and/or operate in conjunction with the present invention.

The apparatus 100 also includes a vehicle service provider communication device or computer 60 (hereinafter “vehicle service provider computer 60”) which is associated with a vehicle service provider, vehicle dealer service department, vehicle repair station or shop and/or any other service or repair facility, who or which utilizes the apparatus and method of the present invention to obtain or utilize vehicle information, vehicle maintenance information and/or vehicle-related information. The vehicle service provider computer(s) 60 can communicate with, and operate in conjunction with, the central processing computer 10 and/or any of the other computers and/or computer systems associated with any of the other individuals and/or entities which utilize and/or operate in conjunction with the present invention.

The apparatus 100 also includes a vehicle parts provider communication device or computer 70 (hereinafter “vehicle parts provider computer 70”) which is associated with a vehicle parts provider, vehicle manufacturer, vehicle dealer parts department, vehicle repair station or shop and/or any other parts seller and/or parts distribution facility, who or which utilizes the apparatus and method of the present invention to obtain or utilize vehicle information, vehicle maintenance information and/or vehicle-related information. The vehicle parts provider computer(s) 70 can communicate with, and operate in conjunction with, the central processing computer 10 and/or any of the other computers and/or computer systems associated with any of the other individuals and/or entities which utilize and/or operate in conjunction with the present invention.

The apparatus 100 also includes a vehicle service payer communication device or computer 80 (hereinafter “service payer computer 80”) which is associated with a vehicle service payer, vehicle manufacturer, vehicle warranty provider, vehicle extended warranty provider, vehicle warranty insurance provider, and/or any other vehicle service payer, who or which utilizes the apparatus and method of the present invention to obtain or utilize vehicle information, vehicle maintenance information and/or vehicle-related information. The service payer computer 80 can communicate with, and operate in conjunction with, the central processing computer 10 and/or any of the other computers and/or computer systems associated with any of the other individuals and/or entities which utilize and/or operate in conjunction with the present invention.

The apparatus 100 also includes a vehicle insurance provider communication device or computer 90 (hereinafter “vehicle insurance computer 90”) which is associated with an insurance provider, an insurance company, a vehicle insurance provider, a vehicle insurance company, a vehicle manufacturer, a vehicle warranty provider, a vehicle extended warranty provider, vehicle warranty insurance provider, and/or any other insurance provider, who or which utilizes the apparatus and method of the present invention to obtain or utilize vehicle information, vehicle maintenance information and/or vehicle-related information. The vehicle insurance computer 90 can communicate with, and operate in conjunction with, the central processing computer 10 and/or any of the other computers and/or computer systems associated with any of the other individuals and/or entities which utilize and/or operate in conjunction with the present invention.

The apparatus 100 also includes an intermediary communication device or computer 95 (hereinafter “intermediary computer 95”) which is associated with any agent, broker, third party, and/or intermediary, who or which acts on behalf of any of users, vehicle owners, vehicle users, vehicle operators, vehicle manufacturers, vehicle dealers, vehicle service providers, vehicle parts providers, vehicle insurers, vehicle insurance providers, vehicle service payers, vehicle warranty providers, vehicle managers, vehicle maintenance managers, described herein. The intermediary computer 95 can communicate with, and operate in conjunction with, the central processing computer 10 and/or any of the other computers and/or computer systems associated with any of the other individuals and/or entities which utilize and/or operate in conjunction with the present invention.

In the preferred embodiment, any of the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, can be any computer or communication device, including, but not limited to, a personal computer, a home computer, a server computer, a network computer, a hand-held computer, a palmtop computer, a laptop computer, a personal communication device, a personal digital assistant, a telephone, a digital telephone, a display telephone, a video telephone, a videophone, a 3G telephone, a television, an interactive television, a beeper, a pager, and/or a watch.

Each of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, can transmit information to, as well as receive information from, any of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, described herein.

In this regard, each of the computers 10, 20, 30, 40, 50, 60, 70, 80, 90, and/or 95, can communicate with, process information from, and/or share data and/or information with, each other and/or with any other computer or computers 10, 20, 30, 40, 50, 60, 70, 80, 90, and/or 95, described herein and/or utilized in conjunction with the present invention. In this manner, data and/or information transfer can occur between any of the computers 10, 20, 30, 40, 50, 60, 70, 80, 90, and/or 95, in a bi-directional manner.

The central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, can communicate with one another, and/or can be linked to one another, over a communication network, a telecommunication network, a telephone network, a line-connected network, and/or a wireless communication network. Each of the computers 10, 20, 30, 40, 50, 60, 70, 80, 90, and/or 95, can be linked with any other computer or computers directly or indirectly directly or indirectly with one another so as to facilitate a direct or indirect bi-directional communication any of said respective computers.

In the preferred embodiment, the present invention is utilized on, and/or over, the Internet and/or the World Wide Web. The present invention, in the preferred embodiment, can also utilize wireless Internet and/or World Wide Web services, equipment and/or devices. The central processing computer(s) 10, as well as any of the other computers 20, 40, 50, 60, 70, 80, 90, and/or 95, in the preferred embodiment, has a web site or web sites associated therewith.

Although the Internet and/or the World Wide Web is a preferred communication system and/or medium utilized, the present invention, in all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a broadband communication network or system, a bluetooth communication network or system, and/or any other communication network or system, and/or any combination of the above communication networks or systems.

In the preferred embodiment, each of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, can transmit data and/or information using TCP/IP, as well as any other Internet and/or World Wide Web, and/or communication, protocols.

The apparatus 100 of the present invention can utilize electronic commerce technologies and security methods, techniques and technologies, in any and/or all of the instances of data and/or information processing, and/or data and/or information transmission described herein.

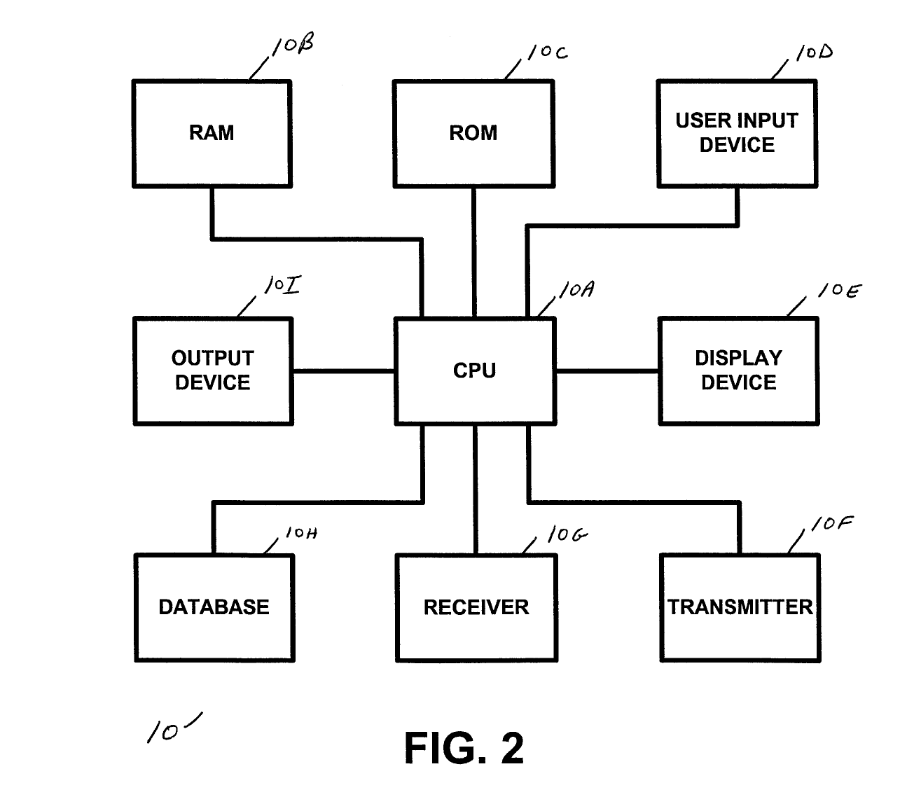

FIG. 2 illustrates the central processing computer 10, in block diagram form. The central processing computer 10, in the preferred embodiment, is a network computer or computer system, or any other communication device which can provide the functionality of, and which can be utilized as a central processing computer such as an Internet server computer and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (PAM) and a read only memory device(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering vehicle data and/or information of any kind, which input device(s) are also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The central processing computer 10 also includes a receiver 10G for receiving signals and/or data and/or information from any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The central processing computer 10 also includes a database(s) 10H which contains data and/or information pertaining to the vehicles which are to be, or which are, maintained by the apparatus and method of the present invention and/or for which information is to be processed.

The database 10H also contains vehicle information for any of the various vehicles which are to be maintained and/or serviced via the present invention including, but not limited to year, make, and model, information, vehicle identification numbers and/or identification information, the various vehicle parts, component parts, and/or systems, which are found in each respective vehicle, data and/or information for performing vehicle diagnostics, data and/or information for diagnosing vehicle problems, malfunctions, symptoms, and/or states of disrepair, maintenance information, maintenance scheduling information, repair and/or servicing procedures, repair, maintenance, and/or servicing costs, servicing guidelines, maintenance guidelines, repair guidelines, servicing procedure time guidelines and/or book limits, repair procedure time guidelines and/or book limits, maintenance procedure time guidelines and/or book limits, servicing procedure price guidelines and/or book limits, repair procedure price guidelines and/or book limits, maintenance procedure price guidelines and/or book limits, repair costs, maintenance costs, servicing costs, repair schedules, maintenance schedules, and/or service schedules, for any of the vehicles which are to be maintained and/or serviced by the apparatus and method of the present invention.

The database 10H also contains data and/or information regarding vehicle ownership, vehicle owner information, chains of title for any of the vehicles described herein, vehicle transfer and/or sale information, warranty information, extended warranty information, warranty claim history for each of the vehicles maintained and/or serviced via the apparatus and method of the present invention. The database 10H also contains the maintenance, servicing, and/or repair, histories for each of the vehicles maintained and/or serviced via the apparatus and method of the present invention. The database 10H also contains maintenance, servicing, and/or repair, schedules for each of the vehicles maintained and/or serviced via the apparatus and method of the present invention.

The database 10H can also contains data and/or information regarding the equipment and parts which are found in each vehicle, vehicle equipment and/or parts listings and/or inventories, and/or any other data and/or information regarding the equipment and parts found in each vehicle, original equipment manufacturer information, after-market provider information, manufacturers information, equipment and/or parts providers information, as well as cross referencing information to substitute and/or replacement equipment and/or parts, for any of the vehicles described herein.

The database 10H also contains data and/or information for diagnosing vehicle problems, malfunctions, states of disrepair, and/or symptoms. The database 10H also contains data and/or information regarding repair and/or servicing procedures to correct and/or repair vehicle problems, malfunctions, states of disrepair, and/or symptoms. The database 10H also contain information regarding vehicle parts, vehicle after-market parts, vehicle services, and/or vehicle after-market services. The database 10H also contain information regarding vehicle parts providers or suppliers, vehicle after-market parts providers or suppliers, vehicle services providers, and/or vehicle after-market services providers.

The database 10H also contains information regarding vehicle manufacturers, vehicle dealers, vehicle sellers, vehicle service providers, repair facilities and/or repair shops, vehicle parts providers, vehicle parts sellers, and/or after-market providers of vehicle parts and/or vehicle services. The database 10H also contains data and/or information regarding parts vendors.

The database 10H also contains data and/or information pertaining to any and/or all of the various users, vehicle owners, vehicle operators, vehicle maintenance managers, vehicle computers, vehicle dealers computers, vehicle manufacturers, vehicle service providers, vehicle parts providers, service payers, vehicle insurance providers, and/or intermediaries, who or which utilize the apparatus and method of the present invention.

The database 10H also contains contact information such as phone numbers, fax numbers, pager numbers, beeper numbers, e-mail addresses, hyperlinks to, and/or any other information which can facilitate contact between any of the various users, vehicle owners, vehicle operators, vehicle maintenance managers, vehicle computers, vehicle dealers computers, vehicle manufacturers, vehicle service providers, vehicle parts providers, service payers, vehicle insurance providers, and/or intermediaries, described herein.

The database 10H can also contain electronic signature data and/or information for any of the various users, vehicle owners, vehicle operators, vehicle maintenance managers, vehicle computers, vehicle dealers computers, vehicle manufacturers, vehicle service providers, vehicle parts providers, service payers, vehicle insurance providers, and/or intermediaries, described herein for facilitating transactions, financial transactions, etc., by and/or between any of the above the various users, vehicle owners, vehicle operators, vehicle maintenance managers, vehicle computers, vehicle dealers computers, vehicle manufacturers, vehicle service providers, vehicle parts providers, service payers, vehicle insurance providers, and/or intermediaries, who or which utilize the apparatus and method of the present invention.

The database 10H also contains data and/or information for performing vehicle diagnostics for any and/or all vehicle diagnostic purposes. The database 10H also contains data and/or information regarding vehicle repair, vehicle maintenance, and vehicle servicing instructions and procedures, for any and/or all of the vehicles which are repaired, maintained and/or serviced by the apparatus and method of the present invention. The database 10H also contains data and/or information regarding instructional materials regarding vehicle repairs, vehicle maintenance procedures, and vehicle servicing procedures, for any and/or all of the vehicles which are repaired, maintained and/or serviced by the apparatus and method of the present invention. The database 10H can also include text materials, video materials, audio materials, video and audio materials, tutorials, and instructional and/or educational materials, for and relating to vehicle use, vehicle operation, vehicle repairs and repair procedures, vehicle maintenance procedures, and vehicle servicing procedures, for any and/or all of the vehicles which are repaired, maintained and/or serviced by the apparatus and method of the present invention.

The database 10H also contains data and/or information for or regarding any repair facilities, maintenance facilities, vehicle dealers, parts providers, vehicle manufacturers, and/or parts providers, who or which utilize and/or provide services for any of the vehicles described herein.

The database 10H can also contain data and/or information regarding manufacturer prescribed maintenance, repair and/or servicing schedules for any of the vehicles described herein as well as maintenance, repair and/or servicing, histories for any of the vehicles described herein. The database 10H can also contain any data and/or information for performing the management of vehicle maintenance programs, vehicle repair programs, and/or vehicle servicing programs.

The database 10H can also contain data and/or information regarding the maintenance, repair and/or servicing, facilities, repair shops, dealers, which have provided maintenance, repair and/or servicing, services for any of the vehicles described herein as well as information regarding any of the mechanics and/or service technicians, who or which have performed maintenance, repair and/or servicing, services for any of the vehicles described herein. The database 10H can also contain data and/or information for or regarding locating repair and/or servicing, facilities, repair shops, dealers, mechanics and/or service technicians, for obtaining the services provided by any of the above entities. The database 10H can also contain data and/or information for or regarding locating parts, equipment, and/or parts providers and/or equipment providers, for obtaining vehicle parts and/or vehicle equipment.

The database 10H can also contain data and/or information regarding vehicle product information, vehicle pricing information, vehicle sales offerings, rebate offering, incentive offerings, vehicle equipment information, vehicle equipment pricing information, vehicle parts information, and vehicle parts pricing information.

The database 10H can also contain data and/or information for or regarding vehicle owner's manuals, including owner's manuals and/or instruction manuals for any of the vehicles described herein. The database 10H can also contain data and/or information regarding vehicle recalls and/or recall information.

The database 10H can also contain any data and/or information for providing auctions and/or bidding for or regarding any of the vehicles, vehicle equipment, vehicle parts, vehicle maintenance procedures, vehicle repair procedures, vehicle servicing procedures, and/or any other products and/or services offered via the apparatus and method of the present invention.

The database 10H can also contain data and/or information for providing information, service reminders, maintenance reminders, repair reminders, and/or any other information to any of the vehicle owners, vehicle operators and/or any of the other respective individuals and/or entities described herein. The database 10H can also contain data and/or information for providing information, reminders, and/or any other information to any of the vehicle dealers, vehicle manufacturers, vehicle service providers, vehicle parts providers, service payers, vehicle insurance providers, and/or intermediaries, who or which utilize the apparatus and method of the present invention.

The database 10H can also contain data and/or information regarding vehicle ownership, vehicle transfer, vehicle ownership history, vehicle title transfer history, vehicle maintenance, repair, and/or servicing history, dates of ownership, and dates of vehicle maintenance, repair, and/or servicing.

The database 10H can also contain data and/or information regarding vehicle pricing including new vehicle pricing information, used vehicle pricing information, vehicle maintenance costs, vehicle repair costs, and vehicle serving costs.

The database 10H can also contain data and/or information regarding the past operating histories and/or characteristics for any of the vehicles described herein, as well as statistical and/or aggregated data and/or information concerning any of the vehicles described herein, including but not limited to, vehicle operating characteristics, vehicle breakdown information, vehicle malfunction information, vehicle failure information, vehicle equipment break-down information, vehicle equipment malfunction information, vehicle equipment failure information, vehicle part(s) break-down information, vehicle part(s) malfunction information, vehicle part(s) failure information, vehicle operating life, vehicle equipment operating life, vehicle part(s) operating life, vehicle repair costs, vehicle equipment replacement and/or repair costs, and/or vehicle part(s) replacement and/or repair costs, and/or any other pertinent information regarding any of the vehicles, vehicle types, vehicle models, and/or vehicle model years, for any of the vehicles described herein.

The database 10H can also contain any data and/or information regarding notifying any of the respective users, vehicle owners, vehicle operators, vehicle maintenance managers, vehicle computers, vehicle dealers computers, vehicle manufacturers, vehicle service providers, vehicle parts providers, service payers, vehicle insurance providers, and/or intermediaries, who or which utilize the apparatus and method of the present invention, of any pertinent information, event, and/or occurrence, which may be of interest to the respective individual or entity.

The database 10H can also contain data and/or information for facilitating the processing of data and/or information obtained from the vehicle, the vehicle computer, the vehicle electronic command computer, and/or from any equipment and or component part of the vehicle. The database 10H can also contain any data and/or information for accessing the vehicle, the vehicle computer, the vehicle electronic command computer, and/or from any equipment and or component part of the vehicle, in order to obtain data and/or information therefrom.

The database 10H can also include data and/or information regarding the credentials, skills, training, and/or specialization(s) of or regarding any of the vehicle service providers, mechanics, technicians, service technicians, and/or other individuals and/or entities who or which provide any of the various maintenance, repair, and/or servicing, services for any of the vehicles described herein. The database 10H can also include the work schedules, schedules, calendars, availability, diaries, etc. of any of the herein-described vehicle service providers, mechanics, technicians, service technicians, and/or other individuals and/or entities who or which provide any of the various maintenance, repair, and/or servicing, services for any of the vehicles described herein. The database 10H can also include data and/or information for scheduling maintenance, repair, and/or service, appointments for any of the herein-described vehicle service providers, mechanics, technicians, service technicians, and/or other individuals and/or entities who or which provide any of the various maintenance, repair, and/or servicing, services.

The database 10H can also include data and/or information for providing advertising for vehicle sales, vehicle leases, vehicle insurance, vehicle financing, vehicle locating, vehicle extended warranties, vehicle accessories, vehicle equipment, vehicle parts, vehicle roadside assistance, vehicle emergency assistance, vehicle maintenance services, vehicle repair services, and/or vehicle servicing services. The database 10H can also include data and/or information for and/or regarding electronic catalogs, electronic coupons, and/or alternative value entities, for purchasing, leasing, and/or obtaining any of the respective vehicles, vehicle insurance, vehicle financing, vehicle locating, vehicle extended warranties, vehicle accessories, vehicle equipment, vehicle parts, vehicle roadside assistance, vehicle emergency assistance, vehicle maintenance services, vehicle repair services, and/or vehicle servicing services. The electronic catalogs and/or coupons can also be utilized for prepaid goods, products, and/or services.

The database 10H can also contain data and/or information for providing vehicle emergency assistance services, roadside assistance, and/or any other previously arranged repair services.

The database 10H can also contain data and/or information regarding vehicle warranty information, warranty instructions and/or procedures, and/or warranty claims procedures.

The database 10H can also contain data and/or information for facilitating and/or for effectuating financial transactions involving any of the herein-described respective users, vehicle owners, vehicle operators, vehicle maintenance managers, vehicle computers, vehicle dealers computers, vehicle manufacturers, vehicle service providers, vehicle parts providers, service payers, vehicle insurance providers, and/or intermediaries, who or which utilize the apparatus and method of the present invention.

The database 10H can also contain any other data and/or information which can be obtained from any of the herein-described users, vehicle owners, vehicle operators, vehicle maintenance managers, vehicle computers, vehicle dealers computers, vehicle manufacturers, vehicle service providers, vehicle parts providers, service payers, vehicle insurance providers, and/or intermediaries, who or which utilize the apparatus and method of the present invention.

The data and/or information in the database 10H can also include links to any other information, information sources, news sources, and/or other information and/or data which can or may be utilized by the present invention and/or by any of the various users, vehicle owners, vehicle operators, vehicle maintenance managers, vehicle computers, vehicle dealers computers, vehicle manufacturers, vehicle service providers, vehicle parts providers, service payers, vehicle insurance providers, and/or intermediaries, who or which utilize the apparatus and method of the present invention.

The database 10H also contains statistical and/or other probabilistic and/or mathematical information for assigning and/or correlating certain levels and/or estimates for any and/or all of the information, diagnoses, repairs, service routines, service procedures, and/or any other information processed and/or generated by the central processing computer 10 and/or the apparatus 100. Applicant hereby incorporates by reference herein the teachings of Basic Business Statistics Concepts and Applications, Mark L. Berenson and David M. Levine, 6^{th} Edition, Prentice Hall 1996.

The database 10H, in the preferred embodiment, can be a database which may include individual databases or collections of databases, with each database being designated to store any and all of the data and/or information described herein. The database 10H, or collection of databases, may be updated by each of the respective users, vehicle owners, vehicle operators, vehicle maintenance managers, vehicle computers, vehicle dealers computers, vehicle manufacturers, vehicle service providers, vehicle parts providers, service payers, vehicle insurance providers, and/or intermediaries, who or which utilize the apparatus and method of the present invention, in real-time, and/or via dynamically linked database management techniques.

The data and/or information stored in the database 10H can also be updated by and/or dynamically linked to, various external sources, including but not limited to vehicle and vehicle-related information sources, news services, research publications, research facilities, research institutions, testing facilities, consumer reporting entities, and/or any of the of the respective users, vehicle owners, vehicle operators, vehicle maintenance managers, vehicle computers, vehicle dealers computers, vehicle manufacturers, vehicle service providers, vehicle parts providers, service payers, vehicle insurance providers, and/or intermediaries, described herein.

The data and/or information which is contained and/or stored in the database 10H, as well as any of the other databases 20H, 30H, 40, 50H, 60H, 70H, 8OH, 90H, and/or 95H, described herein, can be obtained from the various users, vehicle owners, vehicle operators, vehicle manufacturers, vehicle dealers, vehicle service providers, vehicle parts providers, vehicle insurers, vehicle insurance providers, vehicle service payers, vehicle warranty providers, vehicle managers, vehicle maintenance managers, and/or any agents, brokers, and/or intermediaries and/or third parties, described herein.

Data and/or information stored in the database 10H, as well as any of the other databases described herein, can be updated by multiple parties. For example, a vehicle service provider may provide maintenance information for a particular vehicle in a vehicle file, and a different service provider can update a repair history, and/or the vehicle file, for the vehicle upon performing a subsequent repair on the vehicle. The vehicle manufacturer can also update the vehicle file with service information, recall information, and/or any other information which may be pertinent to, and/or related to the vehicle. Should the vehicle owner go to another repair facility or service provider, any and/or all previously stored information could be available for, and can be updateable by, the service provider.

The database 10H can also include statistical data and/or information regarding diagnoses, and/or alternate diagnoses, repair success, repair failure, as well as statistical data and/or information regarding misdiagnoses. The database 10H also contains data and/or information regarding experimental repairs as well as statistical information regarding same, successes of same and failures of same.

In any and/or all of the embodiments described herein, any of the data and/or information which is or which may be stored in the database 10H, and/or any of the other databases described herein, can be utilized and/or can appear in any of the reports, diagnostic reports, repair reports, evaluation reports, provider reports, insurance reports, service payer reports, training reports, and/or any other reports, described herein.

The database 10H can contain any and all information deemed necessary and/or desirable for providing all of the processing and/or services and/or functions described herein. Applicant hereby incorporates by reference herein the subject matter of Fundamentals of Database Systems, by Ramez Elmasri and Shamkant B. Navathe, 2^{nd} Ed., Addison-Wesley Publishing Company, 1994.

The central processing computer 10 also includes an output device 10I for outputting any data, information, report, etc., described herein. In the preferred embodiment, the output device 10I can be a printer, a display, a transmitter, a modem, and/or any other device which can be used to output data.

Any of the data and/or information for any of the users, vehicle owners, vehicle operators, vehicle manufacturers, vehicle dealers, vehicle service providers, vehicle parts providers, vehicle insurers, vehicle insurance providers, vehicle service payers, vehicle warranty providers, vehicle managers, vehicle maintenance managers, and/or any agents, brokers, and/or intermediaries and/or third parties, can be updated by different parties and which such updated data and/or information being made available to other respective parties so as to provide and ensure comprehensive and up-to-date vehicle information, vehicle maintenance information, and/or vehicle-related information.

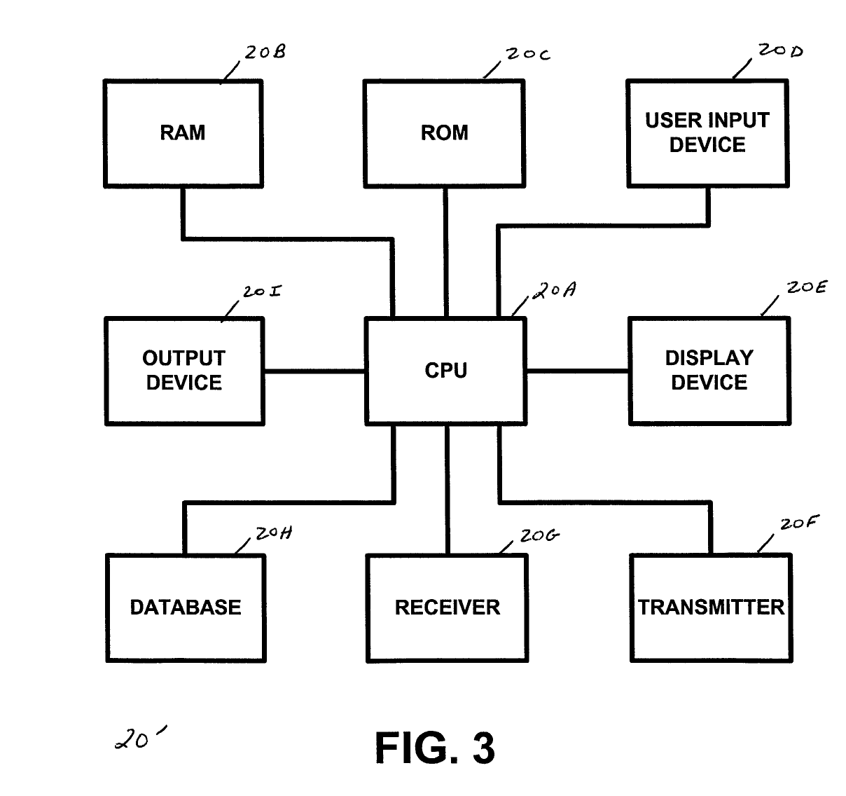

FIG. 3 illustrates the user computer 20, in block diagram form. The user computer 20, in the preferred embodiment, can be personal computer, a network computer or computer system, or any other computer or communication device, which is utilized as a user computer. In the preferred embodiment, the user computer 20 includes a central processing unit or CPU 20A, which in the preferred embodiment, is a microprocessor. The CPU 20A may also be a microcomputer, a minicomputer, a macro-computer, and/or a mainframe computer, depending upon the application.

The user computer 20 also includes a random access memory device(s) 20B (RAM) and a read only memory device(s) 20C (ROM), each of which is connected to the CPU 20A, a user input device 20D, for entering data and/or commands into the user computer 20, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information, which input device(s) are also connected to the CPU 20A. The user computer 20 also includes a display device 20E for displaying data and/or information to a user or operator.

The user computer 20 also includes a transmitter(s) 20F, for transmitting signals and/or data and/or information to any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The user computer 20 also includes a receiver 20G for receiving signals and/or data and/or information from any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The user computer 20 also includes a database(s) 20H. The database 20H can contain and/or be linked to any of the data and/or information described herein as being stored in the database 10H. The database 20H can also contain any data and/or information needed and/or desired for performing any of the processing functions and/or functionality described herein.

The user computer 20 also includes an output device 20I for outputting any data, information, report, etc., described herein. In the preferred embodiment, the output device 20I can be a printer, a display, a transmitter, a modem, and/or any other device which can be used to output data.

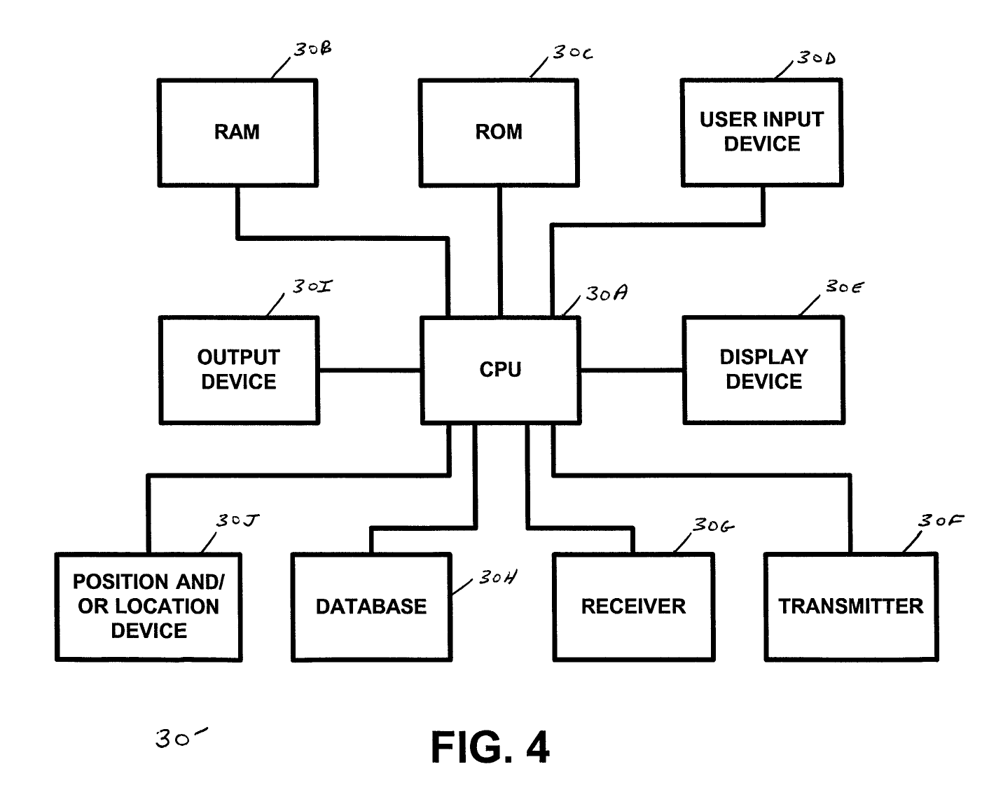

FIG. 4 illustrates the vehicle computer 30, in block diagram form. The vehicle computer 30, in the preferred embodiment, can be a computer, personal computer, computer system, or communication device, which can be utilized to access and/or to communicate with the central processing computer 10 and/or with any of the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, described herein. In the preferred embodiment, the vehicle computer 30 includes a central processing unit or CPU 30A, which in the preferred embodiment, is a microprocessor. The CPU 30A may also be a microcomputer, a minicomputer, a macro-computer, and/or a mainframe computer, depending upon the application.

The vehicle computer 30 also includes a random access memory device(s) 30B (RAM) and a read only memory device(s) 30C (ROM), each of which is connected to the CPU 30A, a user input device 30D, for entering data and/or commands into the vehicle computer 30, which includes any one or more of a keyboard, a scanner, a user pointing device, such as, for example, a mouse, a touch pad, and/or an audio input device and/or a video input device, etc., if desired, which input device(s) are also connected to the CPU 30A. The vehicle computer 30 also includes a display device 30E for displaying data and/or information to a user or operator.

The vehicle computer 30 also includes a transmitter(s) 30F, for transmitting signals and/or data and/or information to any one or more of the central processing computer(s) 10 and to any of the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, described herein.

The vehicle computer 30 also includes a receiver 30G for receiving signals and/or data and/or information from any one or more of the central processing computer(s) 10 and/or from any of the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, described herein.

The provider computer 30 also includes a database(s) 30H which can contain any and/or all of the data and/or information described herein with regards to the database 10H of the central processing computer 10. The database 30H can also contain data and/or information which is particular to a vehicle or group of vehicles. The database 30H can also contain any data and/or information needed and/or desired for performing any of the processing functions and/or functionality described herein.

With reference once again to FIG. 4, the vehicle computer 30 also includes an output device 30I such as a printer, a modem, a fax/modem, or other output device, for providing data and/or information to the operator or user of the vehicle computer 30 or to a third party or third party entity. The vehicle computer 30, in the preferred embodiment, is a computer or computer system which is utilized to access and/or to communicate with the central processing computer 10 and/or with any of the user computers 20, the vehicle computers 30, the vehicle dealer computers 40, the vehicle manufacturer computers 50, the vehicle service provider computers 60, the vehicle parts provider computers 70, the service payer computers 80, the vehicle insurance computers 90 provider, and/or the intermediary computers 95, described herein. The vehicle computer(s) 30 can also communicate with any of the other vehicle computers 30.

The vehicle computer 30 can also include a position and/or location device 30J which can be associated with the vehicle. In any and/or all of the embodiments described herein, the position and/or location device 30J can utilize any suitable and/or appropriate positioning and/or locating devices, systems, and/or technologies, including but not limited to, global positioning system technologies, triangulation technologies, wireless location system technologies, tracking technologies, time difference of arrival locating technologies, and/or any other positioning and/or locating devices, systems, and/or technologies.

The position and/or location device 30J can be connected with and/or linked to the vehicle computer 30 and/or to the CPU 30A. The position and/or location device 30J can provide vehicle position and/or location data and/or information for utilization in any of the embodiments described herein.

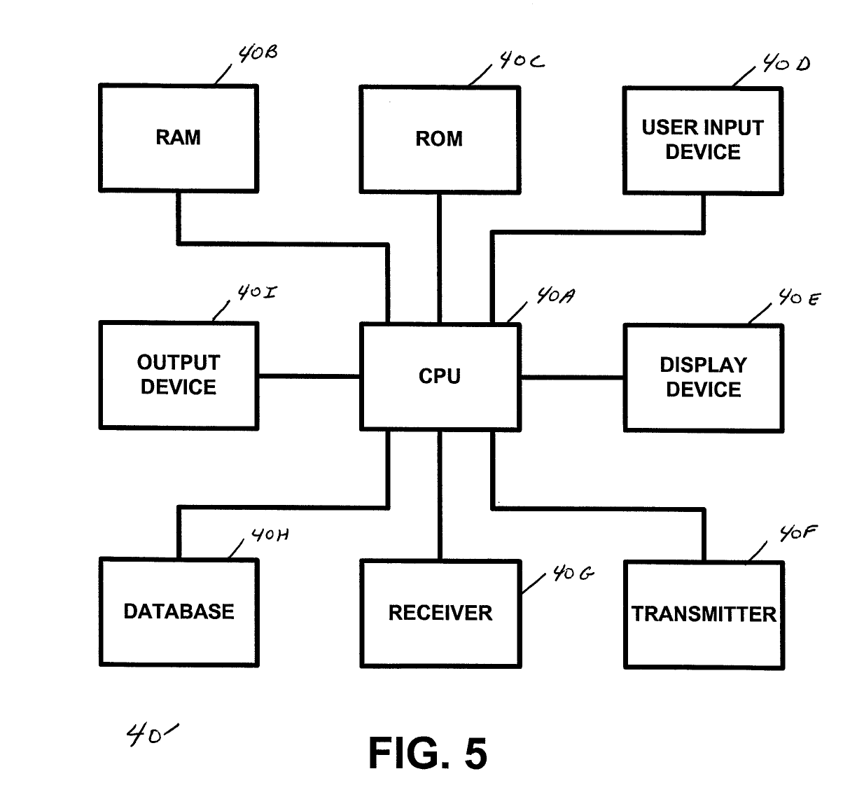

FIG. 5 illustrates the vehicle dealer computer 40, in block diagram form. The vehicle dealer computer 40, in the preferred embodiment, can be personal computer, a network computer or computer system, or any other computer or communication device, which is utilized as a vehicle dealer computer. In the preferred embodiment, the vehicle dealer computer 40 includes a central processing unit or CPU 40A, which in the preferred embodiment, is a microprocessor. The CPU 40A may also be a microcomputer, a minicomputer, a macro-computer, and/or a mainframe computer, depending upon the application.

The vehicle dealer computer 40, also includes a random access memory device(s) 40B (RAM) and a read only memory device(s) 40C (ROM), each of which is connected to the CPU 40A, a user input device 40D, for entering data and/or commands into the vehicle dealer computer 40, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information, which input device(s) are also connected to the CPU 40A. The vehicle dealer computer 40 also includes a display device 40E for displaying data and/or information to a user or operator.

The vehicle dealer computer 40, also includes a transmitter(s) 40F, for transmitting signals and/or data and/or information to any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The vehicle dealer computer 40 also includes a receiver 40G for receiving signals and/or data and/or information from any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The vehicle dealer computer 40 also includes a database(s) 40H. The database 40H can contain and/or be linked to any of the data and/or information described herein as being stored in the database 10H. The database 40H can also contain any data and/or information needed and/or desired for performing any of the processing functions and/or functionality described herein.

The vehicle dealer computer 40 also includes an output device 40I for outputting any data, information, report, etc., described herein. In the preferred embodiment, the output device 40I can be a printer, a display, a transmitter, a modem, and/or any other device which can be used to output data.

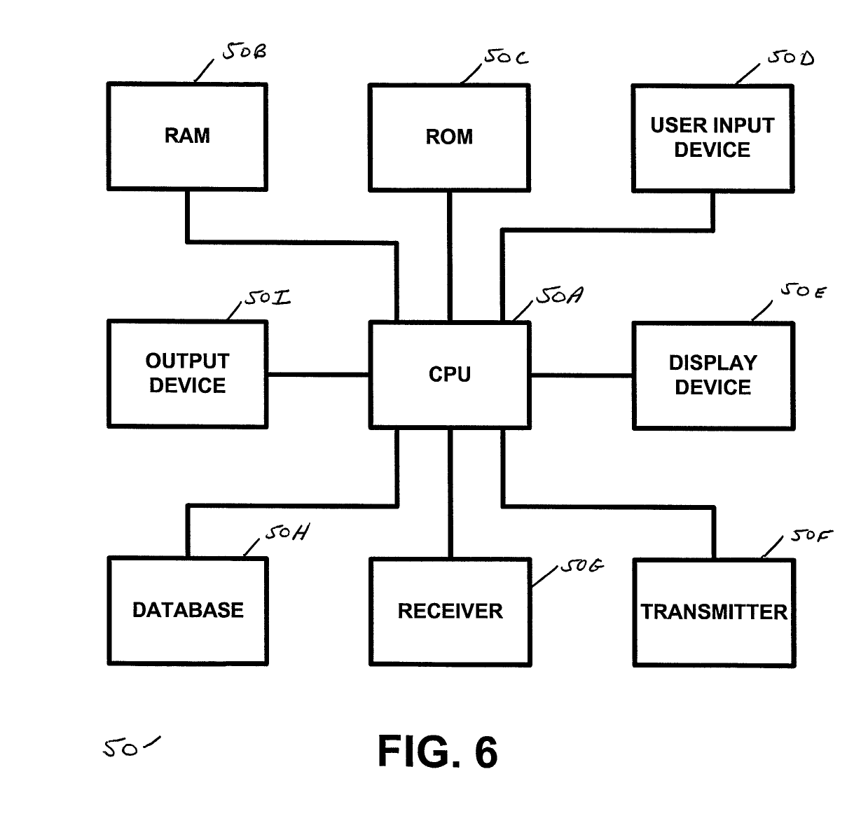

FIG. 6 illustrates the vehicle manufacturer computer 50, in block diagram form. The vehicle manufacturer computer 50, in the preferred embodiment, can be personal computer, a network computer or computer system, or any other computer or communication device, which is utilized as a vehicle manufacturer computer. In the preferred embodiment, the vehicle manufacturer computer 50 includes a central processing unit or CPU 50A, which in the preferred embodiment, is a microprocessor. The CPU 50A may also be a microcomputer, a minicomputer, a macro-computer, and/or a mainframe computer, depending upon the application.

The vehicle manufacturer computer 50, also includes a random access memory device(s) SOB (RAM) and a read only memory device(s) 50C (ROM), each of which is connected to the CPU 50A, a user input device 50D, for entering data and/or commands into the vehicle manufacturer computer 50, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information, which input device(s) are also connected to the CPU 50A. The vehicle manufacturer computer 50 also includes a display device 50E for displaying data and/or information to a user or operator.

The vehicle manufacturer computer 50, also includes a transmitter(s) 50F, for transmitting signals and/or data and/or information to any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The vehicle manufacturer computer 50 also includes a receiver 50G for receiving signals and/or data and/or information from any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The vehicle manufacturer computer 50 also includes a database(s) 50H. The database 50H can contain and/or be linked to any of the data and/or information described herein as being stored in the database 10H. The database 50H can also contain any data and/or information needed and/or desired for performing any of the processing functions and/or functionality described herein.

The vehicle manufacturer computer 50 also includes an output device 50I for outputting any data, information, report, etc., described herein. In the preferred embodiment, the output device 50I can be a printer, a display, a transmitter, a modem, and/or any other device which can be used to output data.

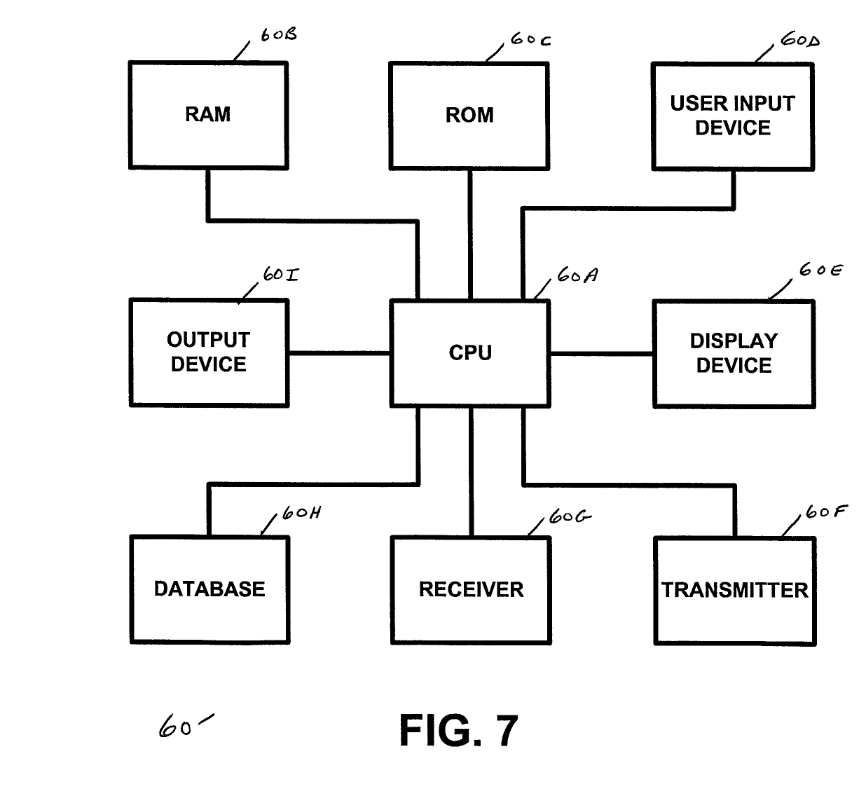

FIG. 7 illustrates the vehicle service provider computer 60, in block diagram form. The vehicle service provider computer 60, in the preferred embodiment, can be personal computer, a network computer or computer system, or any other computer or communication device, which is utilized as a vehicle service provider computer. In the preferred embodiment, the vehicle service provider computer 60 includes a central processing unit or CPU 60A, which in the preferred embodiment, is a microprocessor. The CPU 60A may also be a microcomputer, a minicomputer, a macro-computer, and/or a mainframe computer, depending upon the application.

The vehicle service provider computer 60, also includes a random access memory device(s) 60B (RAM) and a read only memory device(s) 60C (ROM), each of which is connected to the CPU 60A, a user input device 60D, for entering data and/or commands into the vehicle service provider computer 60, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information, which input device(s) are also connected to the CPU 60A. The vehicle service provider computer 60 also includes a display device 60E for displaying data and/or information to a user or operator.

The vehicle service provider computer 60, also includes a transmitter(s) 60F, for transmitting signals and/or data and/or information to any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The vehicle service provider computer 60, also includes a receiver 60G for receiving signals and/or data and/or information from any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The vehicle service provider computer 60 also includes a database(s) 60H. The database 60H can contain and/or be linked to any of the data and/or information described herein as being stored in the database 10H. The database 60H can also contain any data and/or information needed and/or desired for performing any of the processing functions and/or functionality described herein.

The vehicle service provider computer 60 also includes an output device 60I for outputting any data, information, report, etc., described herein. In the preferred embodiment, the output device 60I can be a printer, a display, a transmitter, a modem, and/or any other device which can be used to output data.

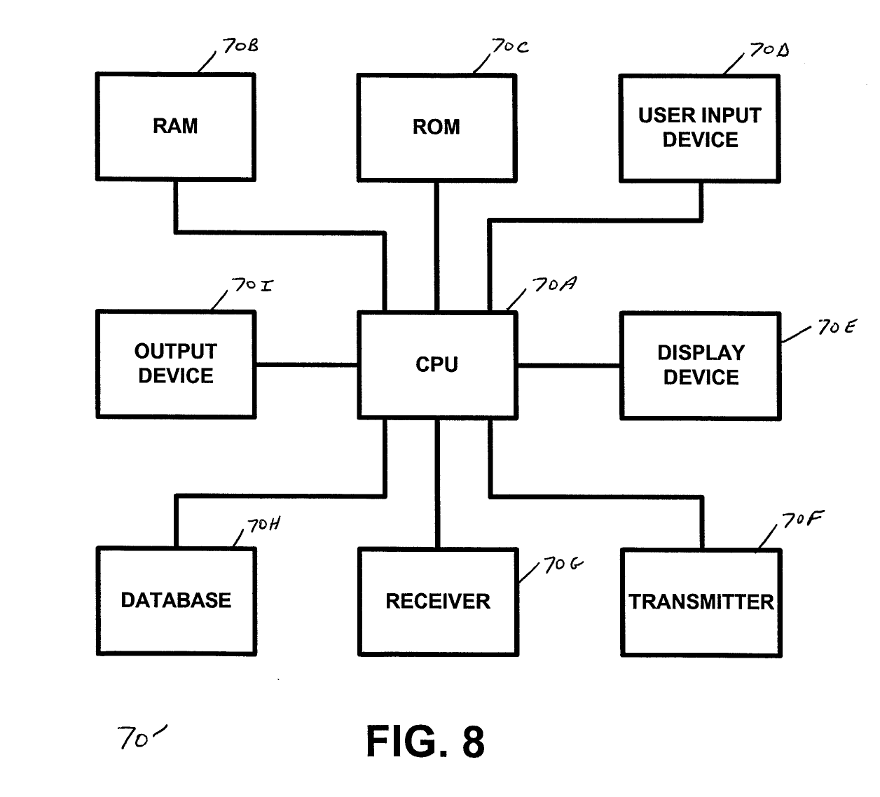

FIG. 8 illustrates the vehicle parts provider computer 70, in block diagram form. The vehicle parts provider computer 70, in the preferred embodiment, can be personal computer, a network computer or computer system, or any other computer or communication device, which is utilized as a vehicle parts provider computer. In the preferred embodiment, the vehicle parts provider computer 70 includes a central processing unit or CPU 70A, which in the preferred embodiment, is a microprocessor. The CPU 70A may also be a microcomputer, a minicomputer, a macro-computer, and/or a mainframe computer, depending upon the application.

The vehicle parts provider computer 70, also includes a random access memory device(s) 70B (RAM) and a read only memory device(s) 70C (ROM), each of which is connected to the CPU 70A, a user input device 70D, for entering data and/or commands into the vehicle parts provider computer 70, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information, which input device(s) are also connected to the CPU 70A. The vehicle parts provider computer 70 also includes a display device 70E for displaying data and/or information to a user or operator.

The vehicle parts provider computer 70, also includes a transmitter(s) 70F, for transmitting signals and/or data and/or information to any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The vehicle parts provider computer 70 also includes a receiver 70G for receiving signals and/or data and/or information from any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The vehicle parts provider computer 70 also includes a database(s) 70H. The database 70H can contain and/or be linked to any of the data and/or information described herein as being stored in the database 10H. The database 70H can also contain any data and/or information needed and/or desired for performing any of the processing functions and/or functionality described herein.

The vehicle parts provider computer 70 also includes an output device 70I for outputting any data, information, report, etc., described herein. In the preferred embodiment, the output device 70I can be a printer, a display, a transmitter, a modem, and/or any other device which can be used to output data.

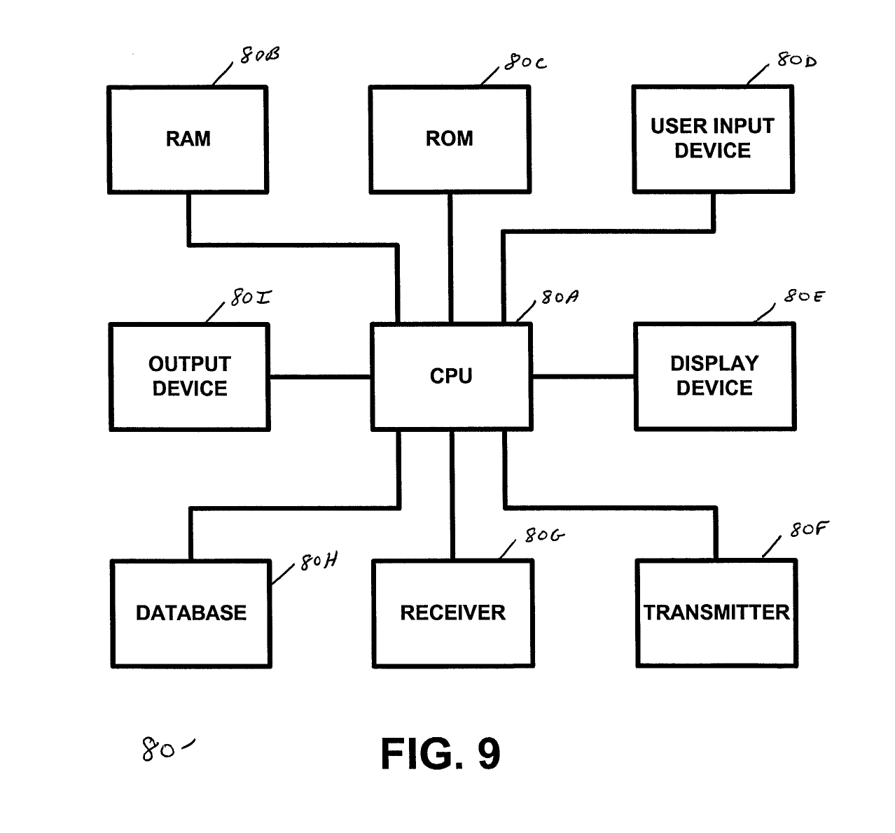

FIG. 9 illustrates the service payer computer 80, in block diagram form. The service payer computer 80, in the preferred embodiment, can be personal computer, a network computer or computer system, or any other computer or communication device, which is utilized as a service payer computer. In the preferred embodiment, the service payer computer 80 includes a central processing unit or CPU 80A, which in the preferred embodiment, is a microprocessor. The CPU 80A may also be a microcomputer, a minicomputer, a macro-computer, and/or a mainframe computer, depending upon the application.

The service payer computer 80, also includes a random access memory device(s) 80B (RAM) and a read only memory device(s) 80C (ROM), each of which is connected to the CPU 80A, a user input device 80D, for entering data and/or commands into the service payer computer 80, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information, which input device(s) are also connected to the CPU 80A. The service payer computer 80 also includes a display device 80E for displaying data and/or information to a user or operator.

The service payer computer 80, also includes a transmitter(s) 80F, for transmitting signals and/or data and/or information to any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The service payer computer 80 also includes a receiver 80G for receiving signals and/or data and/or information from any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The service payer computer 80 also includes a database(s) 80H. The database 80H can contain and/or be linked to any of the data and/or information described herein as being stored in the database 10H. The database 80H can also contain any data and/or information needed and/or desired for performing any of the processing functions and/or functionality described herein.

The service payer computer 80 also includes an output device 80I for outputting any data, information, report, etc., described herein. In the preferred embodiment, the output device 80I can be a printer, a display, a transmitter, a modem, and/or any other device which can be used to output data.

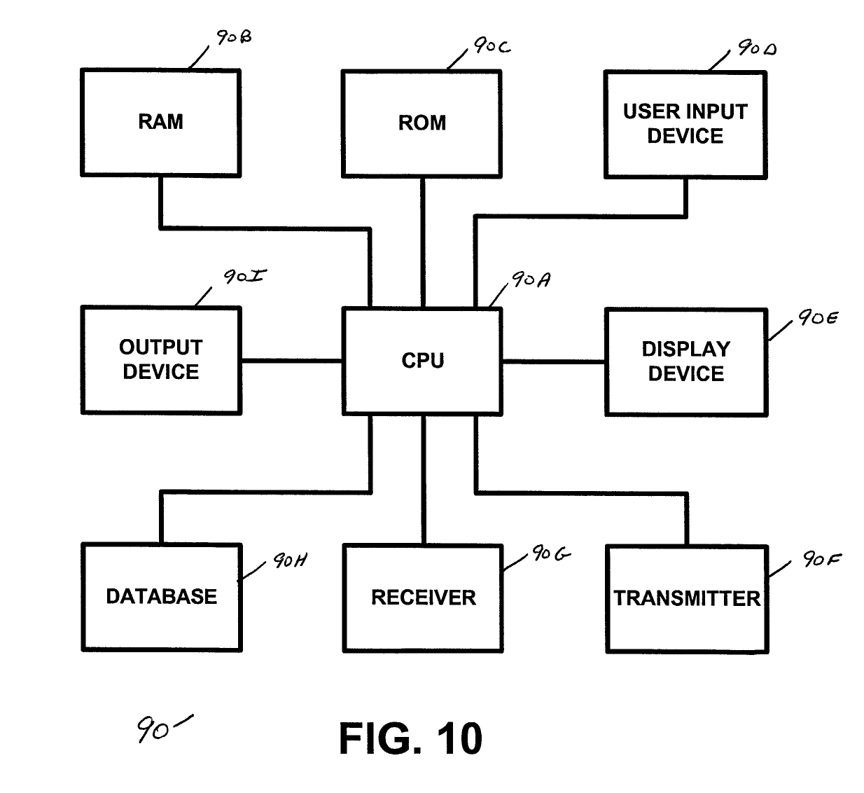

FIG. 10 illustrates the vehicle insurance provider computer 90, in block diagram form. The vehicle insurance provider computer 90, in the preferred embodiment, can be personal computer, a network computer or computer system, or any other computer or communication device, which is utilized as a vehicle insurance provider computer. In the preferred embodiment, the vehicle insurance provider computer 90 includes a central processing unit or CPU 90A, which in the preferred embodiment, is a microprocessor. The CPU 90A may also be a microcomputer, a minicomputer, a macro-computer, and/or a mainframe computer, depending upon the application.

The vehicle insurance provider computer 90, also includes a random access memory device(s) 90B (RAM) and a read only memory device(s) 90C (ROM), each of which is connected to the CPU 90A, a user input device 90D, for entering data and/or commands into the vehicle insurance provider computer 90, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information, which input device(s) are also connected to the CPU 90A. The vehicle insurance provider computer 90 also includes a display device 90E for displaying data and/or information to a user or operator.

The vehicle insurance provider computer 90, also includes a transmitter(s) 90F, for transmitting signals and/or data and/or information to any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The vehicle insurance provider computer 90 also includes a receiver 90G for receiving signals and/or data and/or information from any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The vehicle insurance provider computer 90 also includes a database(s) 90H. The database 90H can contain and/or be linked to any of the data and/or information described herein as being stored in the database 10H. The database 90H can also contain any data and/or information needed and/or desired for performing any of the processing functions and/or functionality described herein.

The vehicle insurance provider computer 90 also includes an output device 90I for outputting any data, information, report, etc., described herein. In the preferred embodiment, the output device 90I can be a printer, a display, a transmitter, a modem, and/or any other device which can be used to output data.

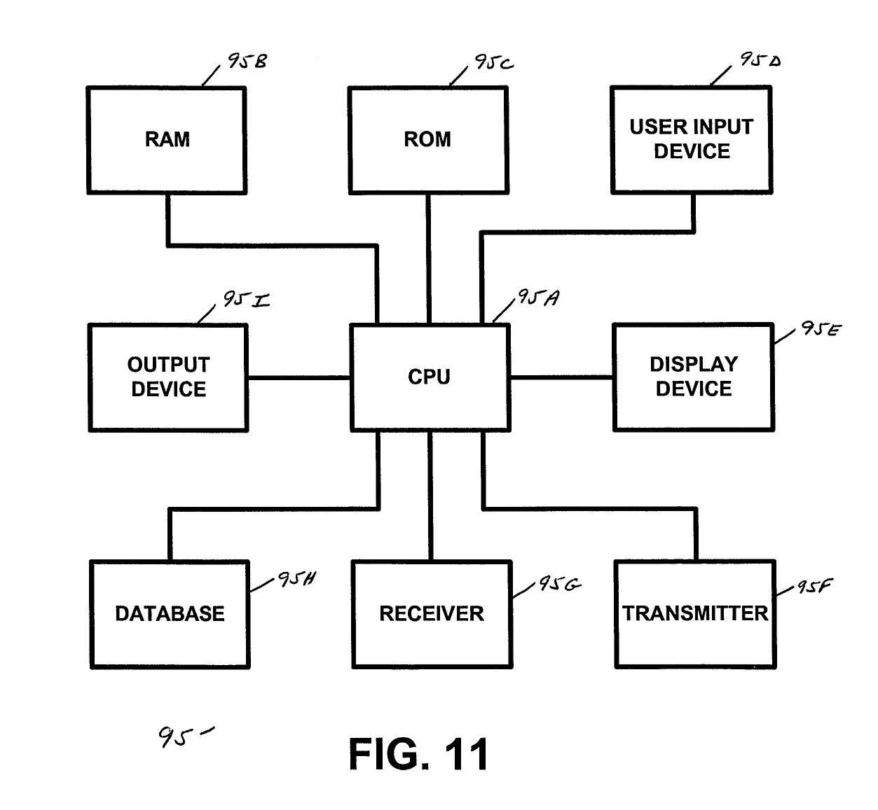

FIG. 11 illustrates the intermediary computer 95, in block diagram form. The intermediary computer 95, in the preferred embodiment, can be personal computer, a network computer or computer system, or any other computer or communication device, which is utilized as a intermediary computer. In the preferred embodiment, the intermediary computer 95 includes a central processing unit or CPU 95A, which in the preferred embodiment, is a microprocessor. The CPU 95A may also be a microcomputer, a minicomputer, a macro-computer, and/or a mainframe computer, depending upon the application.

The intermediary computer 95, also includes a random access memory device(s) 95B (RAM) and a read only memory device(s) 95C (ROM), each of which is connected to the CPU 95A, a user input device 95D, for entering data and/or commands into the intermediary computer 95, which includes any one or more of a keyboard, a scanner, a user pointing device, such as, for example, a mouse, a touch pad, and/or an audio input device and/or a video input device, and/or any device, electronic and/or otherwise which can be utilized for inputting and/or entering data and/or information, which input device(s) are also connected to the CPU 95A. The intermediary computer 95 also includes a display device 95E for displaying data and/or information to a user or operator.

The intermediary computer 95, also includes a transmitter(s) 95F, for transmitting signals and/or data and/or information to any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The intermediary computer 95 also includes a receiver 95G for receiving signals and/or data and/or information from any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, which may be utilized in conjunction with the present invention.

The intermediary computer 95 also includes a database(s) 95H. The database 95H can contain and/or be linked to any of the data and/or information described herein as being stored in the database 10H. The database 95H can also contain any data and/or information needed and/or desired for performing any of the processing functions and/or functionality described herein.

The intermediary computer 95 also includes an output device 95I for outputting any data, information, report, etc., described herein. In the preferred embodiment, the output device 95I can be a printer, a display, a transmitter, a modem, and/or any other device which can be used to output data.

Any of the central processing computers 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, described herein, can include input devices for and any other data and or information which can be input into the respective computer and/or communication device and be transmitted to the central processing computer consistent with the utilization of the present invention as described herein.

Any of the central processing computers 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, described herein, can include input devices for receiving security data and/or information for facilitating secured access to the respective computer(s) and/or to the apparatus 100.

Any of the central processing computers 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, described herein, can include input devices for receiving bio-metric data and/or information, such as, but not limited to, palm print readers or scanners for receiving palm print information, retinal scanners for receiving retinal patterns and/or information, fingerprint readers or scanners for receiving fingerprint patterns and/or information, voice recognition devices for receiving voice recognition information, and/or any other bio-metric devices.

The apparatus and method of the present invention can be utilized in numerous preferred embodiments in order to provide a vast array of vehicle maintenance services, vehicle repair services, vehicle servicing services, and/or any other vehicle-related services, for any one or more of the various parties described herein.

While certain of the preferred embodiments may be described with regards to utilization by a particular party, it is important to note that any of the users, operators, vehicles, vehicle dealers, vehicle manufacturers, vehicle service providers, vehicle parts providers, service payers, vehicle insurance providers, and/or intermediaries, may utilize the present invention in the same, similar and/or analogous manner. For example, a preferred embodiment for determining and/or ascertaining a vehicle problem diagnosis can be described as being utilized by service technician to obtain diagnostic information as well as by a vehicle user, owner, or operator, to ascertain or double check a diagnosis. In the same manner, any other preferred embodiment and/or other uses of the present invention can be utilized by any of the parties described herein.

The present invention, in its various preferred embodiments can be utilized to create and maintain comprehensive vehicle databases which can be accessed via a network environment and/or otherwise, to perform vehicle maintenance services, vehicle repair services, vehicle servicing services, to obtain vehicle information, to obtain vehicle-related information, and/or to provide any other information, services, functions and/or functionality, described herein.

The present invention can also be utilized in order to provide training and continuing education services for vehicle owners, operators, users, vehicle dealers, vehicle manufacturers, vehicle service providers, vehicle parts providers, service payers, vehicle insurance providers, and/or intermediaries, to provide information about vehicles, vehicle maintenance, vehicle repair, vehicle servicing, and/or any other vehicle-related information, to provide vehicle maintenance, vehicle repair, vehicle servicing, scheduling management services, for any of the herein-described parties, to provide notification services for any of the owners, operators, users, vehicle dealers, vehicle manufacturers, vehicle service providers, vehicle parts providers, service payers, vehicle insurance providers, and/or intermediaries, described herein, and/or to locate owners, operators, users, vehicle dealers, vehicle manufacturers, vehicle service providers, vehicle parts providers, service payers, vehicle insurance providers, and/or intermediaries, for any of the parties described herein.

The present invention can also be utilized as a clearinghouse for facilitating the offering, selling, buying, trading, and/or other commerce and/or transactions, involving vehicles, vehicle maintenance, vehicle repairs, vehicle servicing, vehicle sales, vehicle insurance, and/or any other vehicle-related goods, products, and/or services.

In any and/or all of the embodiments described herein, the various computers and/or communication devices 10, 20, 30, 40 50, 60, 70, 80, 90, and/or 95, can be utilized to transmit and/or to receive transmissions, information, messages, and/or notification messages and/or signals to, and/or between, the respective parties associated with the respective computers and/or communication devices.

The transmission of information, messages, and/or notification messages and/or signals, in any and/or all of the embodiments described herein can be effected via any one or more of e-mail messages, telephone messages, beeper or pager messages, physical mail delivery, electronic data transmission, and/or can be made via any other suitable and/or appropriate communication method and/or technique.

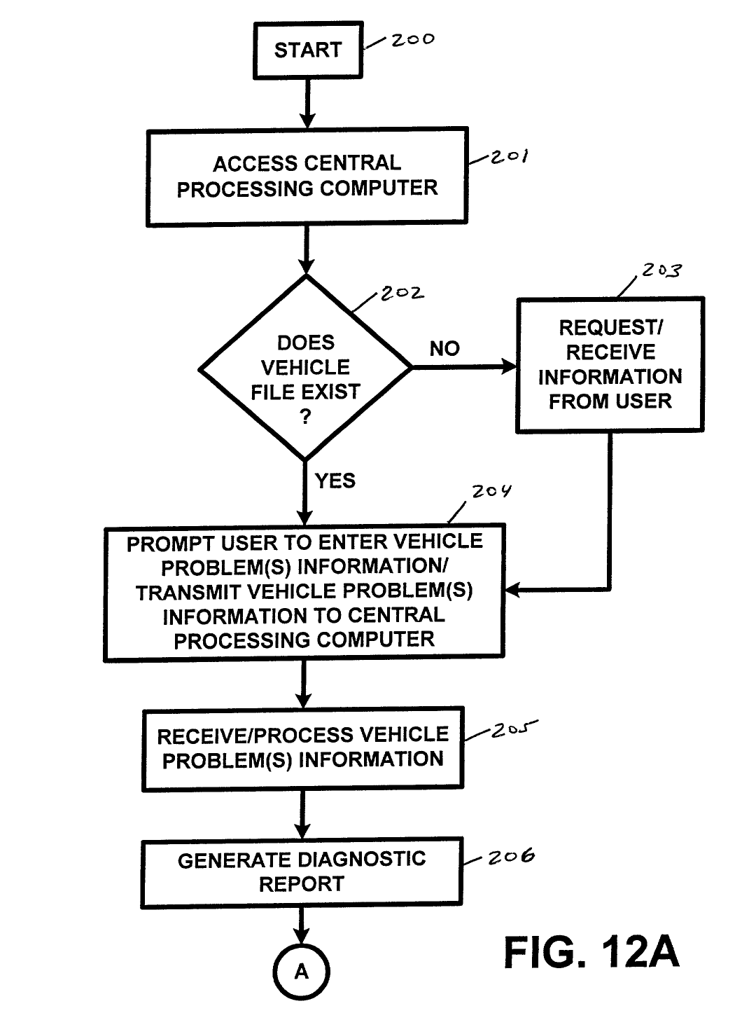

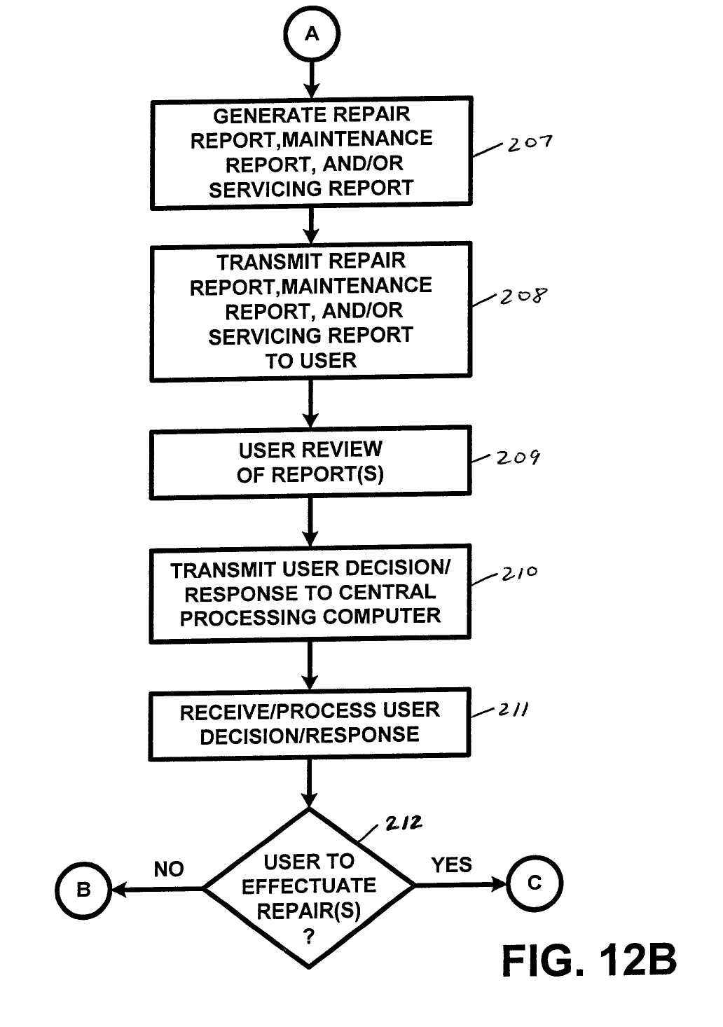

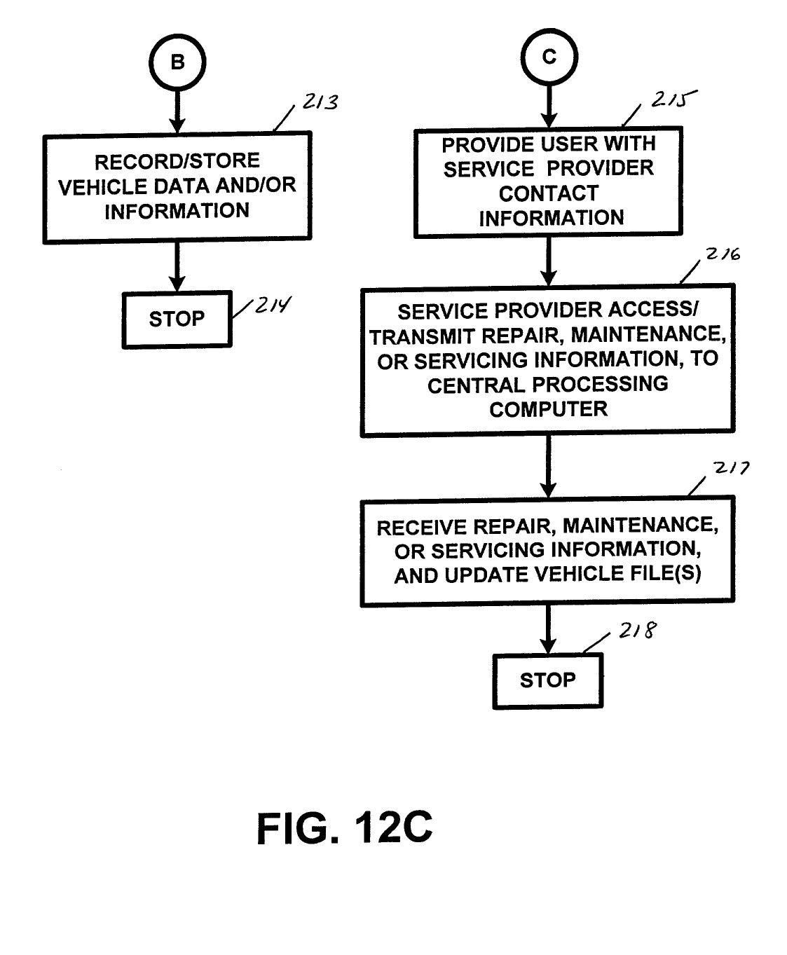

In a preferred embodiment, the present invention can be utilized in order to perform a diagnosis of a vehicle problem, malfunction, and/or state of disrepair. FIGS. 12A, 12B and 12C illustrate a preferred embodiment method of using the present invention, in block diagram form. While the method of FIGS. 12A, 12B and 12C is described in the context of a vehicle owner, user, or operator, obtaining a diagnosis of a vehicle problem, malfunction, or state of disrepair, the method of FIGS. 12A, 12B and 12C can be similarly utilized by vehicle dealers, vehicle manufacturers, vehicle service providers, vehicle parts providers, service payers, vehicle insurance providers, and/or intermediaries, to obtain similar information.

The method of FIGS. 12A, 12B and 12C may also be utilized by any user, operator, owner, vehicle dealers, vehicle manufacturers, vehicle service providers, vehicle parts providers, service payers, vehicle insurance providers, and/or intermediaries, in order to ascertain a diagnosis and/or in order to check on, verify, and/or ascertain the correctness of a diagnosis of another.

The operation of the apparatus 100 commences at step 200. At step 201, the user will access the central processing computer 10 via the user computer 20 and enter data and/or information regarding the user and/or the vehicle in question. At step 202, the central processing computer 10 will determine if a file and/or vehicle maintenance history exists for the vehicle in question. If, at step 202, it is determined that a vehicle maintenance history does not exist, the central processing computer 10 will, at step 203, request that a vehicle maintenance history and/or any other information related thereto be provided by the user.

At step 203, the user can enter the requested information into the user computer 20 and transmit same to the central processing computer 10. The central processing computer 10 can, at step 203, receive and store the information provided by the user. Thereafter, the processing will proceed to step 204.

If, at step 202, it is determined that a vehicle file or vehicle maintenance history does exist, the processing will proceed to step 204. At step 204, the user will be prompted to provide data and/or information regarding the vehicle's problem(s), information regarding the vehicle's malfunction, and/or the vehicle's state of disrepair. The user can enter data and/or information in any appropriate manner. Data and/or information can also be performed by utilizing menus.

At step 204, the data and/or information entered by the user is also transmitted from the user computer 20 to the central processing computer 10. The data and/or information can be transmitted to the central processing computer 10 as it is being entered by the user or after all of the data and/or information has been entered by the user.

The central processing computer 10 will, at step 205 receive and process the vehicle problem(s) data and/or information, in conjunction with any one or more of vehicle diagnostic information, vehicle maintenance information, vehicle repair information, vehicle servicing information, repair procedures, repair instructions, maintenance instructions, the vehicle maintenance history, and/or any other pertinent information for performing diagnostics for vehicles, so as to arrive at a diagnosis of the vehicle's problem(s), malfunctioning, and/or state of disrepair. At step 205, the central processing computer 10 will perform a comprehensive diagnostic evaluation of the vehicle, if needed.

At step 206, the central processing computer 10 will generate a diagnostic report which can include a diagnosis of the vehicle's problem, malfunctioning, and/or state of disrepair. The diagnostic report which is generated at step 206 can, if needed, include a single diagnosis and/or a list of possible diagnoses along with their respective probabilities of occurrence and/or statistical information corresponding thereto, which may pertain to the vehicle.

At step 207, the central processing computer 10 will then generate a repair, maintenance, and/or servicing, report which will outline and/or prescribe the respective repair, maintenance, and/or servicing, procedures for the diagnosis and/or for the possible diagnoses, if pertinent. The central processing computer 10, when generating the repair, maintenance, and/or servicing, report, can process and generate same in conjunction with any one or more of information regarding the cost of the respective repair(s), maintenance, and/or servicing, procedures, the cost of parts, components, equipment, and/or accessories, the maintenance and/or histories, including success rates for similar repairs, maintenance, and/or servicing, procedures for the same or similar vehicles, and/or the value of the vehicle, in order to ascertain the feasibility of performing the repair, the maintenance procedure, and/or the servicing procedure, for the vehicle.

At step 207, the central processing computer 10 can process the vehicle information and diagnostic information in conjunction with the various dealers, service providers, repair facilities, parts providers, accessory providers, equipment providers, warranty providers, service payers, and/or insurance providers, who or which can effect the respective repair, maintenance, and/or servicing, procedure, provide the respective part(s), equipment, component, and/or accessory, and/or can be responsible for paying for the respective repair, maintenance, and/or servicing, procedure, part(s), equipment, component, and/or accessory.

The repair, maintenance, and/or servicing, report, generated at step 207, can also include data and/or information, including contact information and/or links to, dealers, service providers, repair facilities, parts providers, accessory providers, equipment providers, warranty providers, service payers, and/or insurance providers, who or which may be contacted by the user in order to respectively effect the repair, maintenance procedure, servicing procedure, obtain any parts, accessories, equipment, and/or obtain warranty and/or insurance coverage, for respective effect the repair, maintenance procedure, and/or servicing procedure.

The central processing computer 10 can process any of the herein-described data and/or information for or involving mechanical repairs, maintenance, and/or servicing, and/or repairs, maintenance, and/or servicing, involving and/or related to, physical damage (i.e. body work repairs, structural damage, etc.).

At step 208, the central processing computer 10 will transmit the diagnostic report and/or repair, maintenance, and/or servicing, report, to the user's computer 20. At step 209, the user can review the data and/or information which is contained in the diagnostic report and/or the repair, maintenance, and/or servicing, report, and can determine what, if any, action he or she desires to take regarding effectuating any suggested vehicle repair, vehicle maintenance procedure, and/or vehicle servicing procedure.

At step 210, the user can enter and transmit his or her decision regarding whether he or she desires to effectuate the repair, the maintenance procedure, and/or the servicing procedure. At step 211, the central processing computer 10 can receive and process the user's reply. At step 212, the central processing computer 10 will determine if the user has decided to effectuate the repair, the maintenance procedure, and/or the servicing procedure.

If, at step 212, it is determined that the user has decided to not effectuate the repair, the maintenance procedure, and/or the servicing procedure, the operation will proceed to step 213 and the central processing computer 10 will record and store the vehicle data and/or information from the current session in the vehicle file and/or the vehicle history in the database 10H. The data and/or information can thereafter be utilized for processing data and/or information for the vehicle and/or for performing processing routines for or involving any other vehicles. In this manner, the vehicle's file and/or maintenance history can be updated and can be available for the vehicle's next diagnostic session, repair, maintenance procedure, and/or servicing procedure. Thereafter, the operation of the apparatus 100 will cease at step 214.

If, however, at step 212, it is determined that the user has decided to effectuate the repair, the maintenance procedure, and/or the servicing procedure, the operation will proceed to step 215 and the central processing computer 10 will provide the user with contact information for, and/or links or hyperlinks to, any of the various dealers, service providers, repair facilities, parts providers, accessory providers, equipment providers, warranty providers, service payers, and/or insurance providers, who or which may be contacted by the user in order to respectively effect the repair, maintenance procedure, servicing procedure, obtain any parts, accessories, equipment, and/or obtain warranty and/or insurance coverage, for respective effect the repair, maintenance procedure, and/or servicing procedure. Thereafter, the user can effectuate the repair, maintenance procedure, and/or servicing procedure.

At step 216, the dealer, service provider, or the repair facility, can access the central processing computer 10 from its respective computer and transmit data and/or information regarding the repair, maintenance procedure, and/or servicing procedure, which has been performed on or for the vehicle, so as to update the vehicle file and/or vehicle maintenance history.

At step 217, the central processing computer 10 will receive the data and/or information from the respective the dealer, service provider, or the repair facility, update vehicle file and/or vehicle maintenance history, and store same in the database 10H. In this manner, the vehicle's file and/or maintenance history can be updated and can be available for the vehicle's next diagnostic session, repair, maintenance procedure, and/or servicing procedure. Thereafter, the operation of the apparatus will cease at step 218.

At any time during the above-described operation of the apparatus 100, any respective user, owner, operator, vehicle dealer, vehicle manufacturer, vehicle service provider, vehicle parts provider, service payer, vehicle insurance provider, and/or intermediary, can access the central processing computer 10, via the respective user computer(s) 20, vehicle dealer computer(s) 40, vehicle manufacturer computer(s) 50, vehicle service provider computer(s) 60, vehicle parts provider computer(s) 70, service payer computer(s) 80, vehicle insurance provider computer(s) 90, and/or the intermediary computer(s) 95, in order to obtain information regarding a vehicle(s) and/or to input information regarding a vehicle(s).

In another preferred embodiment, the data and/or information regarding the vehicle, which is obtained at step 204, can be uploaded from the vehicle computer 30 to the central processing computer 10 via the communication network. In this manner, the user can access the central processing computer 10 and request that a diagnosis by obtaining data and/or information form the vehicle computer 30 and/or from the vehicle command computer. Thereafter, the central processing computer 10 can access the vehicle computer 30 and/or the vehicle electronic command computer and upload any appropriate and/or respective data and/or information therefrom in order to perform a diagnosis of the vehicle problem, malfunction, and/or state of disrepair.

Applicant hereby incorporates by reference herein the subject matter and teachings of U.S. Pat. No. 5,917,405 which teaches and disclose a control apparatus and methods for vehicles. Applicant also hereby incorporates by reference herein the subject matter and teachings of U.S. patent application Ser. No. 09/551,365 which teaches and discloses a control, monitoring and/or security apparatus and method.

In another preferred, the central processing computer 10 can be programmed to perform periodic diagnostic checks for a vehicle. In this preferred embodiment, the central processing computer 10 can periodically access the vehicle computer 10 and/or the vehicle electronic command computer and upload data and/or information therefrom in order to obtain the data and/or information needed in order to perform diagnostic checks for or regarding the vehicle. In this manner, the central processing computer 10 can perform diagnostic and/or monitoring functions for or regarding any vehicle at any pre-defined interval.

Thereafter, the central processing computer 10 can update a vehicle file or vehicle maintenance history to store the data and/or information obtained from the vehicle computer 30 and/or the vehicle electronic command control computer along with any diagnosis or other related data and/or information which was processed and/or generated by the central processing computer 10.

If, after performing the diagnostic processing operation, it is determined that a repair, a maintenance procedure, or a servicing procedure is needed, the central processing computer 10 can generate and/or transmit an e-mail message, a beeper or pager message, and/or a telephone call and message, and/or any other suitable communication to the user's user computer 20, beeper, pager, and/or telephone, to provide notification to the user of the need for the vehicle repair, maintenance procedure, or servicing procedure. Thereafter, the user can access the central processing computer and the operation of the apparatus 100 can commence from step 206.

In another preferred embodiment, the apparatus and method of the present invention can be utilized in order to provide scheduled maintenance and/or scheduled service reminders to any of the herein-described users, vehicle owners and/or vehicle operators. The maintenance reminders and/or service reminders can be effectuated by generating and transmitting any one or more of an e-mail message(s), an electronic message transmission(s), a pager message(s), a facsimile message(s), a telephone call(s) or message(s), a physical mail delivery, and/or any other suitable communication or correspondence, to the herein-described users, vehicle owners and/or vehicle operators.

In another preferred embodiment, the apparatus and method of the present invention can be utilized in order to provide programmed scheduled maintenance and/or scheduled service reminders to any of the herein-described users, vehicle owners and/or vehicle operators.

In another preferred embodiment, the apparatus and method of the present invention can transmit diagnostic reports, repair reports, maintenance reports, regarding the diagnoses, repairs, maintenance procedures, and/or servicing procedures, which are performed for, on, and/or in conjunction with, any of the vehicles which are serviced by the apparatus 100 to any of the respective vehicle manufacturers, vehicle dealers, vehicle service providers, vehicle repair facilities, vehicle parts providers, vehicle equipment providers, vehicle component providers, vehicle insurance providers, vehicle warranty providers, and/or vehicle service payers, as well as any consumer reporting entities, such as, but not limited to, Consumer Reports® and/or any other consumer reporting services.

The apparatus and method of the present invention can transmit diagnostic reports, repair reports, maintenance reports, regarding the diagnoses, repairs, maintenance procedures, and/or servicing procedures, which are performed for, on, and/or in conjunction with, any of the vehicles which are serviced by the apparatus 100 to any of the users, vehicle owners, vehicle operators, and/or fleet managers, who or which may utilize the apparatus and method of the present invention.

In another preferred embodiment, the diagnostic report, and/or any of the repair, maintenance, and/or servicing, report(s) can be accompanied by repair, maintenance, and/or servicing instructions, instructional materials, video materials, audio materials, audio/visual materials, and/or any other information and/or materials for providing information regarding the vehicle problem, malfunction and/or state of disrepair, and/or the repair procedures, the maintenance procedures, and/or the servicing procedures, which are related to, and/or which are recommended for effectuating and performing, the respective vehicle problem, malfunction and/or state of disrepair.

The diagnostic report, and/or any of the repair, maintenance, and/or servicing, report(s) can also be accompanied by information and/or instructions, for or regarding any vehicle parts, vehicle equipment(s), vehicle components, and/or vehicle accessories. The diagnostic report(s), and/or any of the repair, maintenance, and/or servicing, report(s) can also include installation instructions, in text, video, audio, and/or audio-visual, form for any of the vehicle parts, vehicle equipment(s), vehicle components, and/or vehicle accessories, which may be needed for effectuating and/or performing any repair, maintenance procedure, and/or servicing procedure.

The diagnostic report(s), and/or any of the repair, maintenance, and/or servicing, report(s) can also include preventive maintenance, other vehicle care recommendations and/or tips, and/or vehicle operating warnings and/or vehicle care warnings. Any of the herein-described instructions, materials, and/or other information can be provided in, can accompany, and/or can be linked to, the diagnostic report(s), and/or any of the repair, maintenance, and/or servicing, report(s).

Any of the diagnostic report(s), and/or any of the repair, maintenance, and/or servicing, report(s) can also include statistical information regarding past successful repairs, maintenance, and/or servicing, past unsuccessful repairs, maintenance, and/or servicing, the cost(s) of the repairs, maintenance, and/or servicing, vehicle values, and the feasibility, economic, mechanical, and/or otherwise, or performing the repair, maintenance, and/or servicing, on a vehicle.

In this manner, by utilizing historical as well as other information, the central processing computer 10 and/or the apparatus 100 can provide information to users, vehicle owners, vehicle operators, fleet managers, vehicle manufacturers, vehicle dealers, vehicle service providers, vehicle repair facilities, vehicle parts providers, vehicle equipment providers, vehicle component providers, vehicle insurance providers, vehicle warranty providers, and/or vehicle service payers, regarding the feasibility and/or practicality, of performing the repair, maintenance and/or servicing to or on the vehicle.

As noted above, the method of utilizing the present invention, as described in FIGS. 12A, 12B and 12C, is equally applicable to, and can be utilized in the same manner, by any and/or all of the respective users, vehicle owners, vehicle operators, fleet managers, vehicle manufacturers, vehicle dealers, vehicle service providers, vehicle repair facilities, vehicle parts providers, vehicle equipment providers, vehicle component providers, vehicle insurance providers, vehicle warranty providers, and/or vehicle service payers.

In another preferred embodiment, the apparatus and method of the present invention can be utilized to ensure that a proper repair, maintenance procedure, and/or servicing procedure, is performed on the vehicle, and/or that the correct part(s), equipment(s), component(s), accessory, and/or accessories, is or are obtained.

Referring once again to FIGS. 12A, 12B and 12C and the above description of same, the present invention can be utilized to ensure that a subsequent repair, maintenance procedure, and/or servicing procedure, is performed as needed and or as prescribed and/or that a correct part(s), component, equipment, and/or accessory, is utilized.

As noted above, a vehicle diagnostic report, and/or repair, maintenance, and/or service, report, is stored in the vehicle's file, records, and/or vehicle history, in the database 10H of the central processing computer 10. When the user, owner, or operator, seeks to obtain the repair, maintenance, and/or servicing, services, and/or seeks to obtain a correct part(s), equipment(s), component(s), accessory, and/or accessories, is or are obtained, the respective dealer, manufacturer, service provider, and/or parts provider, can access the central processing computer 10, via its respective computer(s), and ensure that the proper repair(s), maintenance procedures, and/or servicing procedures, are performed and/or that the proper part(s), equipment(s), component(s), accessory, and/or accessories, are obtained and/or utilized. In this manner, the present invention can be utilized in order to prevent mistakes, mishaps and/or other instances when improper repairs, maintenance procedures, and/or servicing procedures, could be performed on a vehicle, and/or instances in which the wrong or improper part(s), equipment(s), component(s), accessory, and/or accessories, could be utilized in the respective repairs, maintenance procedures, and/or servicing procedures.

It is also envisioned that the subsequent service provider and/or parts provider could also re-evaluate the vehicle's condition and/or records and seek additional assistance and/or perform a separate and independent assessment and/or diagnosis of the vehicle. In any event, the present invention can provide the subsequent service provider and/or parts provider with the vehicle's complete history, information, past diagnoses and/or past repairs, maintenance procedures, and/or servicing procedures. In this manner, a subsequent service provider and/or parts provider can be provided with as complete and as up to date information as possible in order to effectuate a vehicle repair, maintenance procedure, and/or servicing procedure.

In another preferred embodiment, the service provider and/or parts provider can access the central processing computer 10 via its respective computer, access the vehicle file or vehicle history, and input information concerning the repair(s), maintenance procedures, and/or servicing procedures, which are to be performed and/or the part(s), equipment(s), component(s), accessory, and/or accessories, which are to be obtained and/or utilized.

Thereafter, the central processing computer 10 can process the information and transmit a message to the respective service provider and/or parts provider notifying the respective service provider and/or parts provider that the respective repair(s), maintenance procedures, and/or servicing procedures, and/or the part(s), equipment(s), component(s), accessory, and/or accessories, which are to be obtained and/or utilized, are correct or appropriate for the vehicle and/or that the respective repair(s), maintenance procedures, and/or servicing procedures, and/or the part(s), equipment(s), component(s), accessory, and/or accessories, which are to be obtained and/or utilized, are incorrect or inappropriate for the vehicle.

The message(s) provided by the central processing computer 10, to the service provider can also include information regarding the repair(s), maintenance procedures, and/or servicing procedures, such as instructions, procedures, steps, and/or any other accompanying information.

In another preferred embodiment, the present invention can be utilized to perform the monitoring of vehicle maintenance, vehicle repair, and/or vehicle servicing. In this manner, the present invention can be utilized by any of the users, owners, operators, dealers, manufacturers, service providers, parts providers, service payers, insurance providers, and/or intermediaries, described herein to evaluate and/or to monitor repairs, maintenance procedures, servicing procedures, parts, equipment, components, and/or accessories, utilized, for a vehicle or vehicles, in order to evaluate repairs, maintenance procedures, servicing procedures, and/or maintenance programs, and/or costs regarding same.

The data and/or information obtained via the present invention can also be utilized for instructional purposes and/or for evaluating, instituting, and/or modifying, vehicle repair programs, maintenance programs, and/or servicing programs. The present invention can also be utilized in order to safeguard against the use of incorrect, unconventional, and/or fraudulent, repairs, maintenance procedures, and/or servicing procedures.

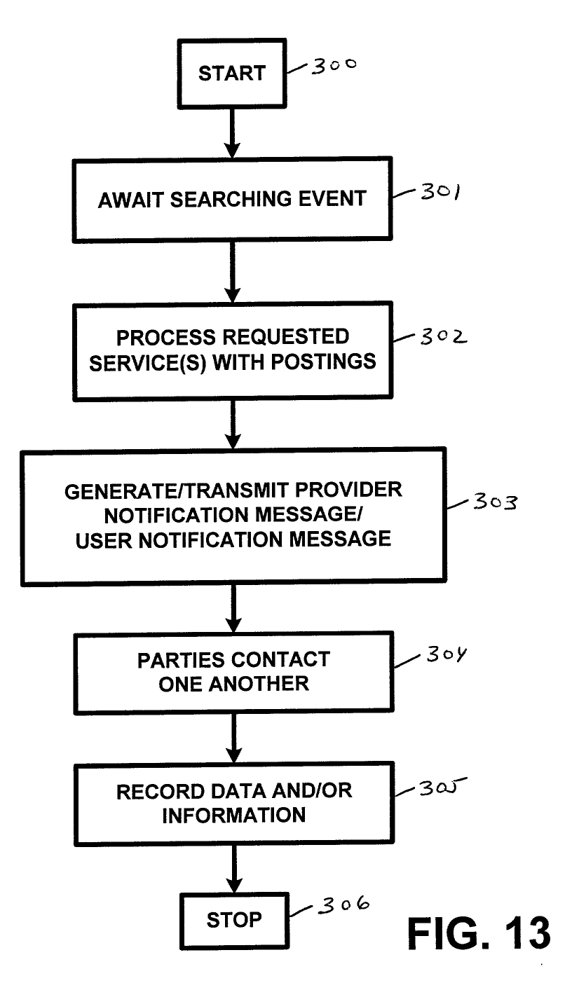

In another preferred embodiment, the apparatus and method of the present invention can be utilized to identify and/or to locate manufacturers, dealers, service providers, repair facilities, service technicians, mechanics, parts, parts providers, equipment, equipment providers, components, components providers, accessories, and/or accessories providers. FIG. 13 illustrates another preferred embodiment method of utilizing the apparatus of the present invention, in flow diagram form.

In the embodiment of FIG. 13, the various and/or respective manufacturers, dealers, service providers, repair facilities, service technicians, mechanics, parts providers, equipment providers, components providers, and/or accessories providers, can access the central processing computer 10 and post information regarding their respective repair services, maintenance services, servicing services, goods, and/or products.

The information can include the types and/or kinds of services, cost and/or price information, conditions for performing services, and/or any other information for engaging the services of the respective manufacturers, dealers, service providers, repair facilities, service technicians, and/or mechanics, and/or for purchasing or obtaining any of the respective parts, equipment, components, and/or accessories, from any of the respective parts, equipment, components, and/or accessories, providers.

The information which is posted by the respective manufacturers, dealers, service providers, repair facilities, service technicians, mechanics, parts providers, equipment providers, components providers, and/or accessories providers, can be stored in the database 10H. The information which is posted by the respective manufacturers, dealers, service providers, repair facilities, service technicians, mechanics, can also include data and/or information regarding vehicle specialists, specialized repairs, and/or specialized servicing routines.

The operation of the apparatus 100 will commence at step 300. At step 301, the central processing computer will await the occurrence of a searching event. The searching event can be any event which can result in the need to obtain the services and/or the parts, equipment, components, and/or accessories, of or from any of the respective manufacturers, dealers, service providers, repair facilities, service technicians, mechanics, parts providers, equipment providers, components providers, and/or accessory providers.

The searching event(s) can include the posting of a request for repair services, maintenance services, servicing services, parts, equipment, components, and/or accessories, which can be made by any of the users, owners, operators, dealers, manufacturers, service providers, parts providers, service payers, insurance providers, and/or intermediaries, who or which utilize the apparatus and method of the present invention. The searching event(s) can also include the generation of a diagnostic report, a repair report, a maintenance report, and/or a service report, by the central processing computer as described herein in conjunction with the embodiment of FIGS. 12A, 12B and 12C.

The searching event can also include any other event or occurrence which can result in the processing the need for the respective repair services, maintenance services, servicing services, parts, equipment, components, and/or accessories, which are posted by the respective providers.

At step 302, the central processing computer 10 will process the requested and/or needed repair services, maintenance services, servicing services, parts, equipment, components, and/or accessories, in conjunction with the postings from the various manufacturers, dealers, service providers, repair facilities, service technicians, mechanics, parts providers, equipment providers, components providers, and/or accessories providers, in order to ascertain the existence and identities of the respective providers who or which can fulfill the requested or needed repair services, maintenance services, servicing services, parts, equipment, components, and/or accessories.

At step 303, the central processing computer will generate a provider notification message and transmit same to each to each of the manufacturers, dealers, service providers, repair facilities, service technicians, mechanics, parts providers, equipment providers, components providers, and/or accessories providers, who or which can fulfill the request or need for the respective repair services, maintenance services, servicing services, parts, equipment, components, and/or accessories. The notification message can contain a contact information for respective user, owner, operator, requesting and/or in need of the respective repair service, maintenance service, servicing service, parts, equipment, components, and/or accessories.

At step 303, the central processing computer 10 can also generate a user, owner, or operator, notification message and transmit same to the user, owner, or operator, requesting and/or in need of the respective repair service, maintenance service, servicing service, parts, equipment, components, and/or accessories. The user, owner, or operator, notification message can contain a contact information for each of the manufacturers, dealers, service providers, repair facilities, service technicians, mechanics, parts providers, equipment providers, components providers, and/or accessories providers, who or which can fulfill the request or need for the respective repair services, maintenance services, servicing services, parts, equipment, components, and/or accessories. The user, owner, or operator, notification message can also contain the cost of price for the respective repair services, maintenance services, servicing services, parts, equipment, components, and/or accessories, as well as any conditions, terms, and/or instructions, regarding obtaining the respective services, parts, equipment, components, and/or accessories.

Thereafter, at step 304, the respective parties can contact each other and enter into any arrangement(s) and/or agreements related to the obtaining and/or providing the for respective services, parts, equipment, components, and/or accessories. At step 305, the central processing computer can record any data and/or information regarding any transactions which may occur at step 304 and store said data and/or information in the database 10H. Thereafter, the operation of the apparatus will cease at step 306.

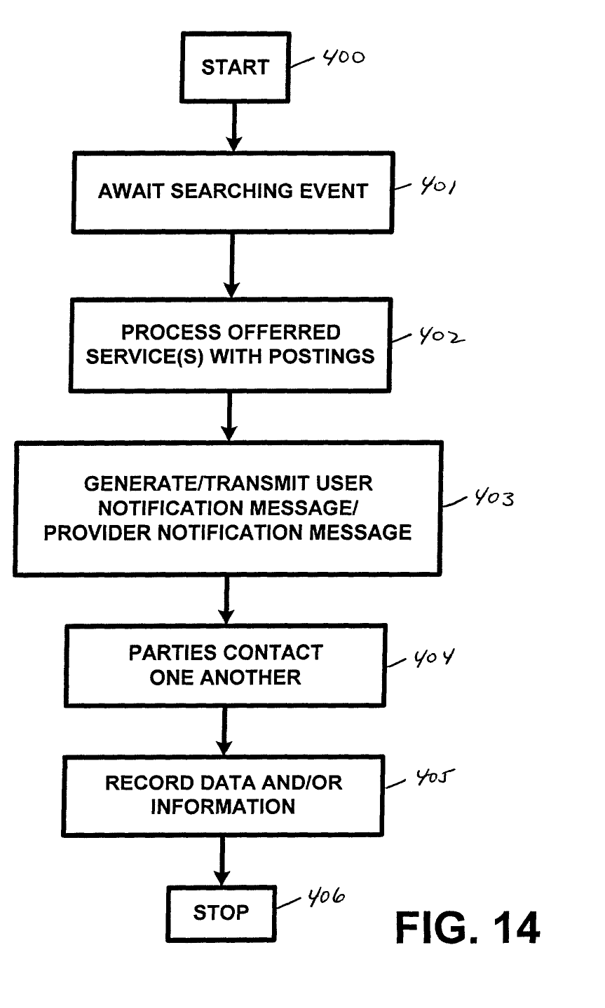

In another preferred embodiment, the apparatus and method of the present invention can be utilized to identify users, owners, and/or operators, who or which may be in need and/or require repairs, maintenance procedures, servicing procedures, parts, equipment, components, and/or accessories. FIG. 14 illustrates another preferred embodiment method of utilizing the apparatus of the present invention, in flow diagram form.

In the embodiment of FIG. 14, the user, owner, or operator, can post a request for repair services, maintenance services, servicing services, parts, equipment, components, and/or accessories, for a vehicle(s). The information can include the types and/or kinds of services needed, price(s) willing to be paid, conditions for engaging the user, owner, or operator, and/or any other information for engaging the user, owner, or operator.

The information which is posted by the respective user, owner, or operator, can be stored in the database 10H. The information which is posted by the respective user, owner, or operator, can also include data and/or information regarding the need for a specialist, a specialized repair, and/or specialized servicing routine.

The operation of the apparatus 100 will commence at step 400. At step 401, the central processing computer 10 will await the occurrence of a searching event. The searching event can be any event which can result in the need to provide a repair, a maintenance procedure, a servicing procedure, a part(s), equipment, a component(s), an accessory and/or accessories, for or to a user, owner, or operator.

The searching event(s) can include the posting of information regarding the availability or offering of repair services, maintenance services, servicing services, parts, equipment, components, and/or accessories.

The information can include the types and/or kinds of services, cost and/or price information, conditions for performing services, and/or any other information for engaging the services of the respective manufacturers, dealers, service providers, repair facilities, service technicians, and/or mechanics, and/or for purchasing or obtaining any of the respective parts, equipment, components, and/or accessories, from any of the respective parts, equipment, components, and/or accessories, providers. The searching event(s) can also include the generation of a diagnostic report, a repair report, a maintenance report, and/or a service report, by the central processing computer 10 as described herein in conjunction with the embodiment of FIGS. 12A, 12B and 12C.

At step 402, the central processing computer 10 will process the offered repair services, maintenance services, servicing services, parts, equipment, components, and/or accessories, in conjunction with the postings from the various users, owners, or operators, in order to ascertain the existence and identities of the users, owners or operators, who or which may utilize the offered services, parts, equipment, components, and/or accessories.

At step 403, the central processing computer will generate a user, owner, or operator, notification message and transmit same to the user, owner, or operator, who or which can utilize the offered repair services, maintenance services, servicing services, parts, equipment, components, and/or accessories. The user, owner, or operator, notification message can contain a contact information for the respective manufacturers, dealers, service providers, repair facilities, service technicians, mechanics, parts providers, equipment providers, components providers, and/or accessories providers. The user, owner, or operator, notification message can also include the price offering from the provider(s) for the respective repair services, maintenance services, servicing services, parts, equipment, components, and/or accessories.

At step 403, the central processing computer 10 can also generate a provider notification message and transmit same to the manufacturers, dealers, service providers, repair facilities, service technicians, mechanics, parts providers, equipment providers, components providers, and/or accessories providers. The provider notification message can contain contact information for the user, owner, or operator, who or which are in need of the respective repair services, maintenance services, servicing services, parts, equipment, components, and/or accessories.

The provider notification message can also contain information regarding the price(s) which the user, owner, or operator, is willing to pay for the respective repair services, maintenance services, servicing services, parts, equipment, components, and/or accessories, as well as any conditions, terms, and/or instructions, regarding being engaged by the user, owner, or operator.

Thereafter, at step 404, the respective parties can contact each other and enter into any arrangement(s) and/or agreements related to the obtaining and/or providing the respective services, parts, equipment, components, and/or accessories to the user, owner, or operator. At step 405, the central processing computer 10 can record any data and/or information regarding any transactions which may occur at step 404 and store said data and/or information in the database 10H. Thereafter, the operation of the apparatus 100 will cease at step 406.

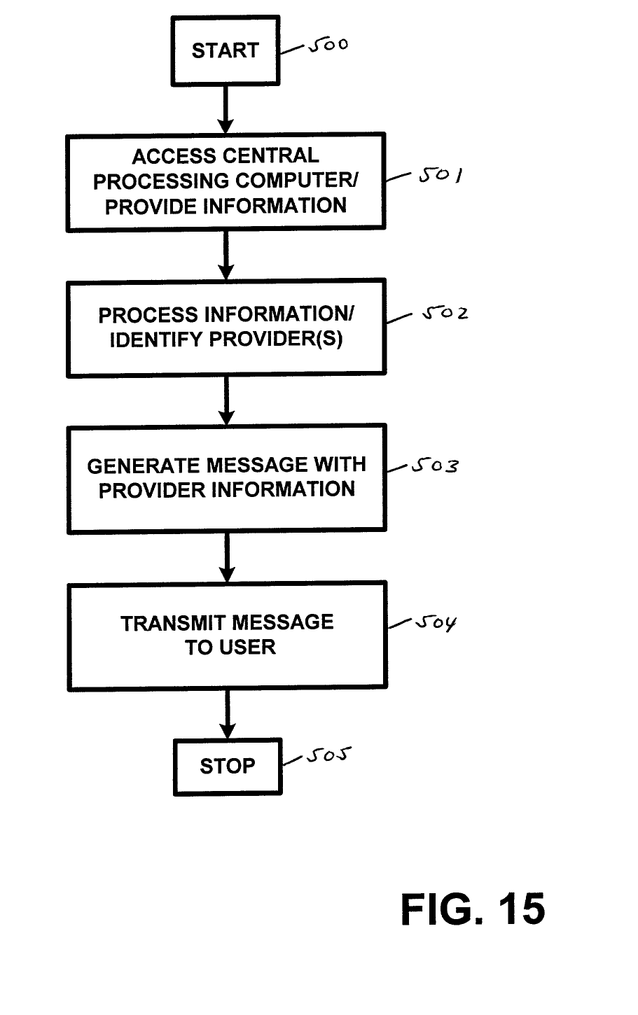

In another preferred embodiment, the present invention can be utilized by any user, owner or operator, can utilize the present invention in order to locate a dealer, a service provider, a service technician, a mechanic, a specialist, a specialized facility, a parts provider, an equipment provider, a component provider, and/or an accessory provider. For example, assume that a vehicle diagnosis indicates that the vehicle is in need of a specialized repair with specialized equipment and that the user, owner, or operator, would have to locate a repair facility having the special equipment. FIG. 15 illustrates another alternate embodiment method for utilizing the apparatus of present invention, in flow diagram form.

With reference to FIG. 15, the operation of the apparatus 100 commences at step 500. At step 501, the user, owner, or operator, accesses that central processing computer 10 and provides information regarding the repair or service needed. At step 502, the central processing computer 10 will process the request and identify one or more service providers who or which can provide the specialized repair or service.

At step 503, the central processing computer 10 can generate a message containing information regarding the service provider or specialist, along with contact information for the service provider or specialist, and transmit same to the user, owner, or operator, at step 504. Thereafter, operation of the apparatus 100 will cease at step 505.

In another similar manner, the embodiment of FIG. 15 can be utilized to identity or locate any vehicle(s), manufacturer(s), dealer(s), service provider(s), repair facility or facilities, service technician(s), mechanic(s), parts provider(s), equipment provider(s), components provider(s), accessories provider(s), insurance provider, and/or service payer.

In another similar manner, the embodiment of FIG. 15 can be utilized to identity or locate an insurance provider or service payer for providing desired insurance and/or repair warranty coverage for any vehicles described herein.

In another preferred embodiment, including in any and/or all of the embodiments described herein, the present invention can be utilized for providing scheduling services for, and/or on behalf of, any of the dealers, service providers, repair facilities, service technicians, mechanics, described herein. In this embodiment, the present invention can maintain work schedules, and/or scheduling data and/or information, of and for any of the dealers, service providers, repair facilities, service technicians, mechanics, described herein.

The above-described schedules, and/or scheduling data and/or information, can be stored in the database 10H of the central processing computer 10. The schedules, and/or scheduling data and/or information, can also be stored and/or provided at any of the respective the dealer computers 40 and/or service provider computers 60 and/or may be stored in any of the respective databases 40H and/or 60H.

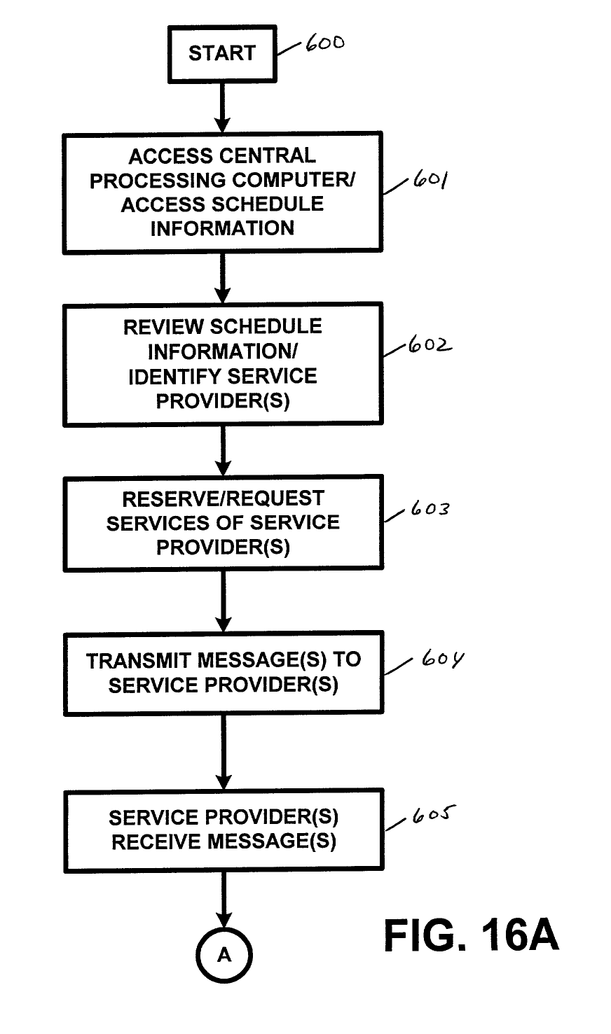

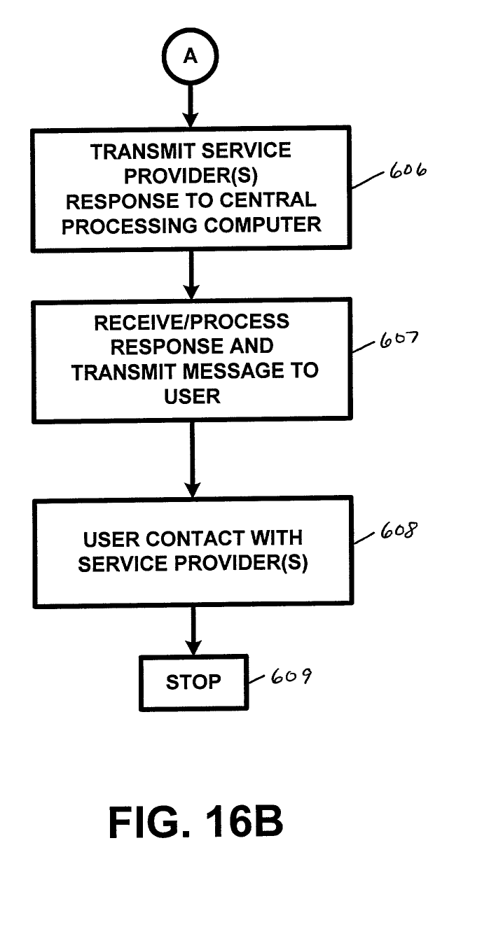

An user, owner, or operator, can utilize the schedules and/or scheduling data and/or information in order to reserve, engage, and/or request, the services of a dealer, service provider, service technician, or mechanic. FIGS. 16A and 16B illustrate another preferred embodiment method for utilizing the apparatus 100 of the present invention. With reference to FIGS. 16A and 16B, the operation of the apparatus commences at step 600.

At step 601, the user, owner, or operator, can access the central processing computer 10 and access data and/or information concerning the schedules or work schedules or of a certain dealer, service provider, service technician, or mechanic, and/or the work schedules of any number of dealers, service providers, service technicians, or mechanics. The dealer(s), service provider(s), service technician(s), or mechanic(s), can be identified via a search which can also be performed at step 601 and/or may be a dealer(s), service provider(s), service technician(s), or mechanic(s), already known by the user, owner, or operator, and/or recommended to the user, owner, or operator.

At step 602, the user, owner, or operator, may review the schedules and/or scheduling data and/or information until it identifies be a dealer(s), service provider(s), service technician(s), or mechanic(s), who or which is acceptable and available for the dates and/or times, as well as places, needed by the user, owner, or operator.

Once the user, owner, or operator, locates a dealer(s), service provider(s), service technician(s), or mechanic(s), the user, owner, or operator, can, at step 603, reserve, engage, and/or request, the services of the dealer(s), service provider(s), service technician(s), or mechanic(s), by transmitting an appropriate message from the user computer 20 to the central processing computer 10. The message can include the amount which the user, owner, or operator, is willing to pay for the services of the dealer(s), service provider(s), service technician(s), or mechanic(s).

Thereafter, the central processing computer 10, at step 604, will transmit a message to the dealer(s), service provider(s), service technician(s), or mechanic(s) or the respective computer(s) associated with the dealer(s), service provider(s), service technician(s), or mechanic(s), and/or otherwise notify the dealer(s), service provider(s), service technician(s), or mechanic(s).

At step 605, the dealer(s), service provider(s), service technician(s), or mechanic(s), can receive the message in real-time and/or otherwise. The dealer(s), service provider(s), service technician(s), or mechanic(s), can thereafter, at step 606, confirm the reservation, agree to the engagement, and/or otherwise reply to the request, respectively, via transmitting a message from the respective dealer computer 40 or service provider computer 60 to the central processing computer 10.

At step 607, the central processing computer 10 will receive the response, process same, and transmit a message to the user computer 20 of the user, owner, or operator, thereby notifying the user, owner, or operator, of the confirmed reservation, the confirmed agreement to the engagement, and/or the reply, respectively. Thereafter, at step 608, the user, owner, or operator, can be put into contact with the dealer(s), service provider(s), service technician(s), or mechanic(s), as they see fit. Thereafter, the operation of the apparatus 100 will cease at step 609.

In another embodiment, the central processing computer 10 can be programmed to confirm a reservation, agree to an engagement, and/or issue a reply, respectively, for, or on behalf, of a dealer(s), a service provider(s), a service technician(s), and/or a mechanic(s).

In another preferred embodiment, the central processing computer 10 can be programmed to provide a user, owner, or operator, with conditions under which dealer(s), service provider(s), service technician(s), or mechanic(s), will agree to a reservation, an engagement, and/or a request. One of these conditions can include payment in advance, a down payment, and/or an option payment, for the services of the dealer(s), service provider(s), service technician(s), or mechanic(s).

The central processing computer 10 can administer and/or maintain a financial account(s) for, or on behalf of any of, the users, owners, or operators, and/or any of the dealer(s), service provider(s), service technician(s), or mechanic(s), insurance providers, service payers, and/or intermediaries described herein. The financial accounts may be bank accounts, electronic money accounts, credit accounts, debit account, and/or any other accounts for facilitating financial transactions.

The central processing computer 10 can make a payment and/or transfer, on behalf of an users, owners, or operators, from the user's, owner's, or operator's, account, to a dealer's, service provider's, service technician's, or mechanic's, account or to accounts of dealers, service providers, service technicians, or mechanics, thereby receiving payment for, or on behalf of, the dealer(s), service provider(s), service technician(s), or mechanic(s), whichever the case may be.

As noted above, the user, owner, or operator, can also secure and/or reserve the services of a dealer(s), service provider(s), service technician(s), or mechanic(s), by purchasing an option from the dealer(s), service provider(s), service technician(s), or mechanic(s), or person or entity representing the dealer(s), service provider(s), service technician(s), or mechanic(s), individual, for the respective dealer(s), service provider(s), service technician(s), or mechanic(s), services, with the price of said option being determined by using conventional financial options pricing models and/or methods. Applicant hereby incorporates by reference herein the subject matter of Options Futures, and Other Derivatives, Third Edition, by John C. Hull, Prentice Hall, 1997.

In another embodiment, the central processing computer 10 can be programmed to accept or reject, an offer to provide services, for, or on behalf, of a user, owner, or operator.

In another preferred embodiment, the apparatus and method of the present can be utilized as vehicle repair, maintenance and/or servicing, training simulator for any of the manufacturers, dealers, service providers service technicians, and/or mechanics, described herein. The present invention can also be utilized by any user, owner, or operator, desiring to learn about a certain vehicle repair, vehicle maintenance, and/or vehicle servicing, topic.

The present invention can be utilized to provide formal training, supplemental training, informal training, continuing education training, and/or any other training, to any respective individual.

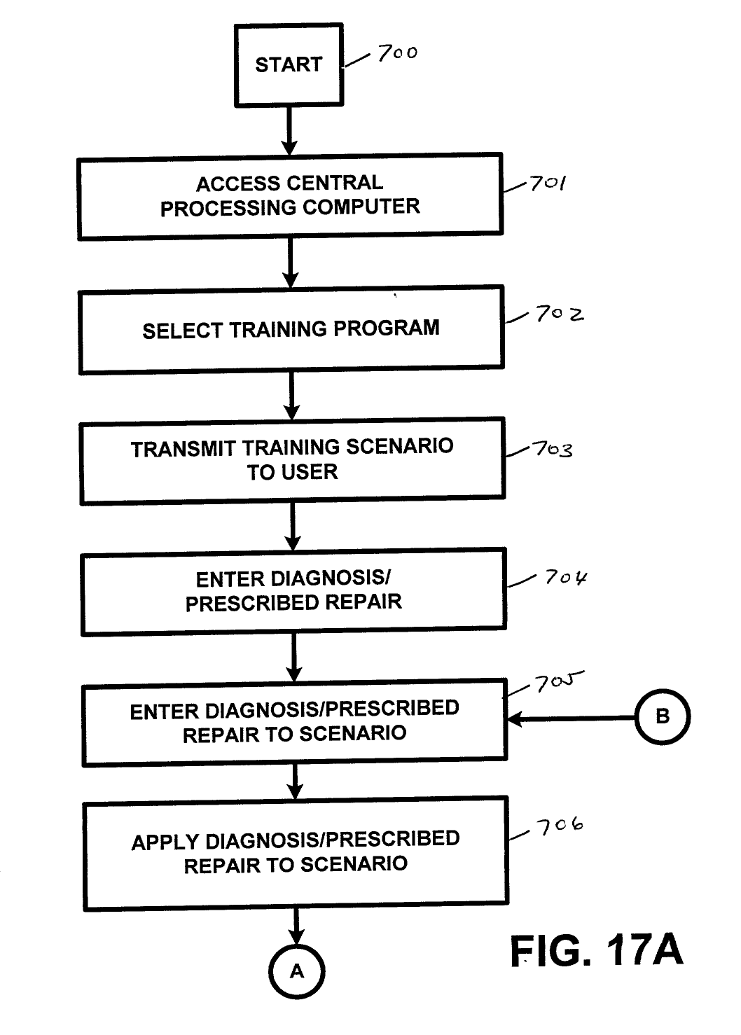

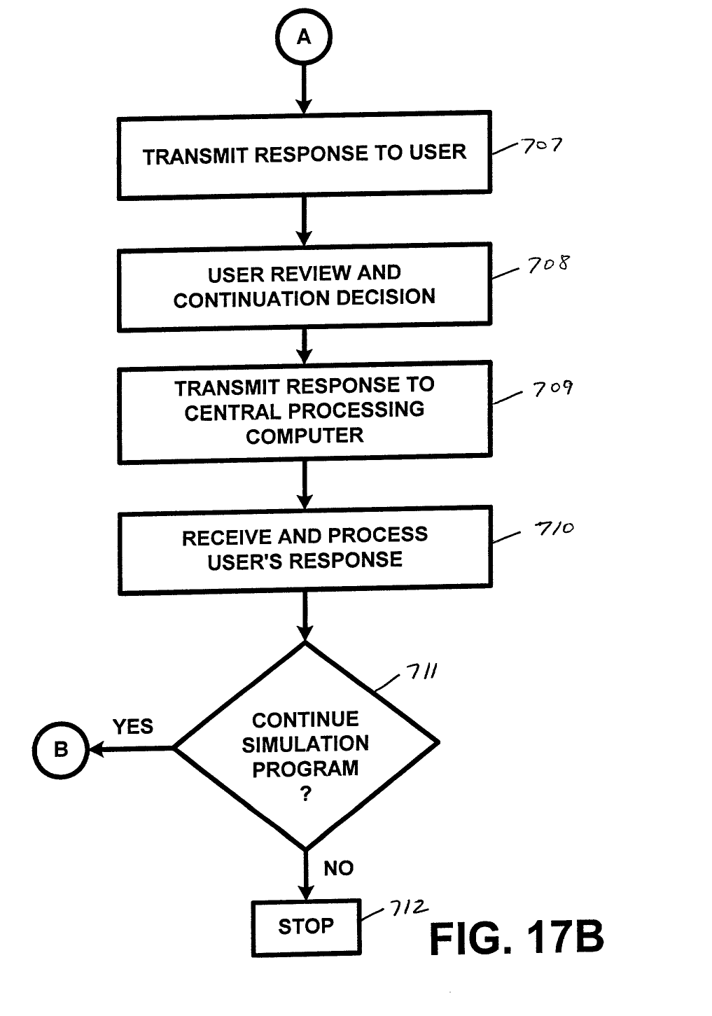

FIGS. 17A and 17B illustrate another preferred embodiment method for utilizing the present invention, in flow diagram form. The operation of the apparatus commences at step 700. At step 701, the individual utilizing the training simulator (referred to hereinafter as “the user”) who could be any provider, student provider, and/or any other individual and/or party described herein, can access the central processing computer 10 via an appropriate computer or communication device.

At step 702, the user can select the training program which he or she wishes to train from. At step 703, the central processing computer 10 will transmit the training scenario and/or information, including the vehicle problems, symptoms, malfunction(s), and/or state(s) of disrepair. The training scenario can include any one or more of text information, a video tapped file or video clip, audio information, and/or any other multimedia information.

At step 704, the user can enter his or her diagnosis and prescribed repair, maintenance and/or servicing, procedure and can transmit same to the central processing computer 10. At step 705, the user's diagnosis and prescribed repair, maintenance and/or servicing, procedure can be received by the central processing computer 10 and can then be applied to the scenario. At step 706, the central processing computer 10 will compare the diagnosis against any diagnosis or diagnoses which are known to be correct and/or against any scientific and/or statistical norms.

At step 706, the central processing computer 10 will apply the prescribed repair, maintenance and/or servicing, procedure to the hypothetical vehicle and compute a revised set of problems, symptoms and/or conditions, if applicable. Once again, statistical information can be utilized to arrive at a realistic response to the repair, maintenance and/or servicing, procedure. The user's diagnosis and prescribed repair, maintenance and/or servicing, procedure, as well as information regarding the correctness and/or viability of same can be recorded by the central processing computer 10 at step 706.

At step 707, the central processing computer 10 will transmit a response to the user's diagnosis and prescribed repair, maintenance and/or servicing, procedure. The response can include the vehicle's response to, or state after, the prescribed repair, maintenance and/or servicing, procedure, and/or an evaluation of the diagnosis and prescribed repair, maintenance and/or servicing, procedure.

The response can also include training materials, which can include any one or more of text information, video information, and/or audio information. At step 708, the user can review the material and/or information contained in the response and can decide whether he or she wishes to continue the training simulation. At step 709, the user will transmit a response to the central processing computer 10 which contains an instruction to either continue the simulation, in which case the user's response will also include a revised diagnosis and prescribed repair, maintenance and/or servicing, procedure, or to terminate the training simulation.

At step 710, the central processing computer 10 will receive and process the user's response provided at step 709. At step 711, the central processing computer 10 will determine whether the user desires to continue the simulation or whether the user desires to terminate the simulation. If, at step 711, it is determined that the user desires to continue the training simulation, the operation of the central processing computer 10 returns to step 705 and the above-described process will be repeated from step 705.

If, however, it is determined that the user desires to terminate the training simulation the operation of the apparatus 100 will cease at step 712. User responses, including diagnostic and repair, maintenance and/or servicing, decisions, can be recorded and/or can be stored and, thereafter the information can be utilized to evaluate the user and/or for comparing the user's progress and/or improvements, as well as aptitude and skills, in the pertinent field of training, and/or the information, can be utilized for any other useful purpose.

In this manner the apparatus and method of the present invention can be utilized to provide an interactive vehicle repair, maintenance and/or servicing, training simulator which can be utilized for training in any and/or all of the fields of vehicle repair, maintenance and/or servicing, fields and/or in other vehicle-related field.

Data and/or information collected and/or stored by the apparatus 100, which relates to vehicle repair, maintenance and/or servicing, procedures, as well as responses to repair, maintenance and/or servicing, procedures, can be utilized in order to present realistic training scenarios. In this manner, the present invention can be utilized to compile a vast amount of information relating to the various fields of vehicle repair, maintenance, and/or servicing. The information can then be utilized to provide realistic training for providers and/or student providers. In this manner, the present invention can utilize information obtained from other preferred embodiments in order to provide simulated training scenarios.

In another preferred embodiment, the present invention can be utilized to facilitate vehicle repair claims processing. Any of the users, owners, operators, manufacturers, dealers, service providers, repair facilities, service technicians, mechanics, insurance providers, service payers, and/or other individuals and/or entities, can file claims with a respective counter party electronically via the present invention. Claim forms can be accessed from a respective party's computer, filled out, and submitted electronically by the claiming party or claimant. Any and/or all submissions can be electronically dated and/or otherwise marked, the status of the claim can be provided to the claimant at any time and any interested third parties may be notified of any action taken on a claim.

In another preferred embodiment, the apparatus and method of the present invention can be utilized to provide for the bidding for, and/or the auctioning off of, any of the herein-described vehicle repair services, vehicle maintenance services, vehicle servicing services, vehicle parts, vehicle equipment, vehicle components, vehicle accessories, vehicle insurance policies, vehicle warranties, vehicle extended warranties, and/or any other vehicle and/or vehicle-related services, goods, and/or products, by any of the respective users, vehicle owners, vehicle operators, vehicle managers, manufacturers, dealers, service providers, parts providers, equipment providers, component providers, accessory providers, insurance providers, and/or service payers.

The apparatus and method of the present invention can also be utilized to provide for the bidding for, and/or the auctioning off of, the business or patronage of any of the users,

vehicle owners, vehicle operators, vehicle managers, manufacturers, dealers, service providers, parts providers, equipment providers, component providers, accessory providers, insurance providers, and/or service payers.

Applicant hereby incorporates by reference herein the subject matter of U.S. Provisional Patent Application Ser. No. 60/120,883 which teaches an apparatus and method for effectuating commerce in a network environment. Applicant also hereby incorporates by reference herein the subject matter of U.S. patent application Ser. No. 09/498,143 which teaches and discloses an apparatus and method for effectuating commerce in a network environment.

When utilized to perform bidding and/or auctioning activities, the respective users, vehicle owners, vehicle operators, vehicle managers, manufacturers, dealers, service providers, parts providers, equipment providers, component providers, accessory providers, insurance providers, and/or service payers, can direct their respective bidding activity or activities and/or auctioning activity or activities to any single, group of, and/or combination of any, user(s), vehicle owner(s), vehicle operator(s), vehicle manager(s), manufacturer(s), dealer(s), service provider(s), parts provider(s), equipment provider(s), component provider(s), accessory provider(s), insurance provider(s), and/or service payer(s).

The bidding and/or auctioning activities can be directed to any of the users, vehicle owners, vehicle operators, vehicle managers, manufacturers, dealers, service providers, parts providers, equipment providers, component providers, accessory providers, insurance providers, and/or service payers, which may be specified and/or identified by or from, any of the various searching routines described herein.

Any and/or all of the respective bidding activities and/or auctioning activities can be effected via e-mail messages, electronic message transmissions, electronic catalogs, electronic coupons, pager messages, facsimile messages, telephone calls or messages, physical mail delivery, and/or via any other method, means and/or mode of communication.

Applicant hereby incorporates by reference herein the subject matter of U.S. Pat. No. 5,862,223 which teaches and discloses and discloses a method and apparatus for a cryptographically-assisted commercial network system designed to facilitate and support expert-based commerce; the subject matter of U.S. Pat. No. 5,797,127 which teaches and discloses a method, apparatus, and program for pricing, selling, and exercising options to purchase airline tickets; and U. S. Pat. No. 5,794,207 which teaches and discloses a method and apparatus for a cryptographically assisted commercial network system designed to facilitate buyer-driven conditional purchase offers.

In another preferred embodiment, as well as in any and/or all of the embodiments described herein, the present invention can generate electronic catalogs and/or electronic coupons for use by any of the respective vehicle manufacturers, vehicle dealers, vehicle service providers, vehicle parts providers, vehicle insurers, vehicle insurance providers, vehicle service payers, vehicle warranty providers, vehicle managers, vehicle maintenance managers, and/or any agents, brokers, and/or intermediaries, to publicize and/or to advertise their respective vehicles, vehicle pair services, vehicle maintenance services, vehicle servicing services, vehicles parts, vehicle equipment, vehicle components, and/or vehicle accessories. The electronic catalogs can be utilized to publicize and/or advertise regular offerings, special offerings, and/or sale offerings.

Applicant hereby incorporates by reference herein the subject matter and teachings of U.S. Provisional Patent Application Ser. No. 60/137,689 which teaches and discloses an apparatus and method for providing an electronic catalog and/or an electronic coupon. Applicant also hereby incorporates by reference herein the subject matter and teachings of U.S. patent application Ser. No. 09/579,358 which teaches and discloses an apparatus and method for providing an electronic catalog and/or an electronic coupon.

Any and/or all of the electronic catalogs and/or electronic coupons described herein can be generated and/or transmitted as e-mail messages and/or electronic message transmissions and can include text information, resume information, video information and/or audio information.

Any and/or all of the electronic catalogs and/or electronic coupons described herein can be generated automatically by the central processing computer 10 and/or by any of the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, described herein.

Any of the central processing computers 10, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, described herein, can be programmed to generate and/or to transmit any of the e-mails, electronic message transmissions, electronic catalogs and/or electronic coupons described herein.

In any and/or all of the embodiments described herein, any user, vehicle computer, vehicle dealer, vehicle manufacturer, vehicle service provider, vehicle parts provider, service payer, vehicle insurance provider, and/or intermediary, can access any one or more of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, via any one or more of the said computers and/or communication devices 10, 20, 30, 40, 50, 60, 70, 80, 90, and/or 95, as well as via any computer and/or communication device.

In this manner, any of the herein-described parties can access the present invention from any computer and/or communication device. Public kiosks with links to any of the computers and/or communication devices 10, 20, 30, 40, 50, 60, 70, 80, 90, and/or 95, can also be utilized to access and utilize the present invention and/or any of the computers and/or communication devices described herein.

In any and/or all of the embodiments described herein, access to any and/or all of the data, information, records. files, etc., which is stored in any of the databases 10H, 20H, 30H, 40H, 50H, 60H, 70H, 80H, 90H, and/or 95H, can be restricted to preserve the security and confidentiality of same. Any of the, users, vehicle owners, vehicle operators, vehicle manufacturers, vehicle dealers, vehicle service providers, vehicle parts providers, vehicle insurers, vehicle insurance providers, vehicle service payers, vehicle warranty providers, vehicle managers, vehicle maintenance managers, and/or any agents, brokers, and/or intermediaries and/or third parties, who or which acts on behalf of another and/or assists in to providing vehicle, vehicle maintenance, and/or related services, can be provided with identification and/or other cards or codes with any and/or all pertinent data regarding the respective individual and/or party provided on the card.

The identification card, in the preferred embodiment can contain a magnetic strip for storing any and/or all pertinent information, a “smart card” for storing information, and/or a bar code or bard codes for storing identification information as well as any other information described herein as being pertinent to the respective users, vehicle owners, vehicle operators, vehicle manufacturers, vehicle dealers, vehicle service providers, vehicle parts providers, vehicle insurers, vehicle insurance providers, vehicle service payers, vehicle warranty providers, vehicle managers, vehicle maintenance managers, and/or any agents, brokers, and/or intermediaries and/or third parties, who or which acts on behalf of another and/or assists in to providing vehicle, vehicle maintenance, and/or related services.

Each of the central processing computer(s) 10, the user computers 20, the vehicle computers 30, the vehicle dealer computers 40, the vehicle manufacturer computers 50, the vehicle service provider computers 60, the vehicle parts provider computers 70, the service payer computers 80, the vehicle insurance provider computer 90, and/or the intermediary computers 95, as well as any other computer and/or communication device, can include suitable devices for reading, scanning, and/or obtaining information which may be stored on the identification card. In this manner, access to the present invention, and the respective use thereof, can be facilitated by the above-described identification card(s).

Any and/or all of the data and/or information described herein can be compiled and processed using statistical calculations in order to update the stored data and/or information with such data and/or information being made available to the respective users, owners, operators, manufacturers, dealers, service providers, repair facilities, service technicians, mechanics, parts providers, equipment providers, component providers, and/or accessory providers, who or which utilize the present invention.

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of the respective the user(s), owner(s), operator(s), manufacturer(s), dealer(s), service provider(s), repair facility or facilities, service technician(s), mechanic(s), parts provider(s), equipment provider(s), component provider(s), accessory provider(s), insurance provider(s), service payer(s), and/or intermediaries, described herein, so as to act on behalf of the respective party as well as to perform any of processing functions and/or other functions described herein.

The intelligent agent can act on behalf of the respective party in various related interactions and/or other activities which are described as being performed herein and/or which may be incidental and/or related thereto. Therefore, the present invention also provides an agent-based apparatus and method for providing vehicle information, vehicle maintenance information and/or vehicle-related information.

Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

The apparatus of the present invention, in any and/or all of the embodiments described herein, can also be programmed to be self-activating and/or activated automatically.

The apparatus of the present invention can also be programmed in order to automatically generate and/or transmit any of the e-mails, electronic message transmissions, electronic notification transmissions, electronic catalogs, electronic coupons, and/or any of the communications, which are described herein, between any of the parties which utilize the present invention.

In any and/or all of the embodiments described herein, any electronic messages, such as e-mails, electronic message transmissions, pager messages, telephone calls or messages, facsimile transmissions, etc., which are generated by the central processing computer 10, and/or any of the other computer 20, 30, 40, 50, 60, 70, 80, 90, and/or 95, can contain appropriate hyperlinks, and/or forwarding information, to the sending party to another electronic message and/or e-mail, to a third party, to other information, and/or to another information source. In this manner, for example, an e-mail message, transmitted from and/or on behalf of a respective manufacturer, dealer, service provider, parts provider, insurance provider, service payer, and/or intermediary, to a user, vehicle owner, or vehicle operator, can contain a hyperlink(s) to the respective manufacturer's, dealer's, service provider's, parts provider's, insurance provider's, and/or service payer's, web site or web page and/or of the web site or web page of any other manufacturer(s), dealer(s), service provider(s), parts provider(s), insurance provider(s), and/or service payer(s).

The present invention, in any and/or all of the herein-described embodiments, can utilize electronic commerce technologies and security methods, techniques and technologies, as described and as set forth in Electronic Commerce Technical, Business, and Legal Issues, Nabil R. Adam, et al. Prentice Hall, 1999 and Web Security & Commerce, Simson Garfinkel with Gene Spafford, O'Reilly 1997, the subject matter of which are hereby incorporated by reference herein.

The communications networks and/or systems on, or over, which the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, wireless communication networks or systems, wireless Internet networks or systems, wireless World Wide Web networks or systems, as well as in, or on any internets and/or intranets, the Internet, the World Wide Web, and any other suitable communication network or system.

The data and/or information, described as being stored in the database 10H and/or in any of the other databases described herein, can be continuously updated so as to store the latest values for the data and/or information and can be stored and be made available for future processing routines.

Any and/or all of the data and/or information described herein, which is stored in the database 10H, or in the collection of databases, can be linked via relational database techniques and/or via any appropriate database management techniques. The data and/or information, in the preferred embodiments, can be updated via inputs from any of the computers and/or communication devices 10, 20, 30, 40, and/or 50, and/or external computers or communication devices, described herein, in real-time, and/or via dynamically linked database management techniques. The above-described updates can also be provided from other information sources via the communication network.

The data and/or information which is stored in the database 10H and/or which may be otherwise utilized with, and/or in conjunction with, the apparatus and method of the present invention, can be linked via any suitable data linking techniques such as, for example, dynamically linked lists (DLLs), linked lists, and object links embedded (OLE's). Any suitable database management technique(s) may also be utilized in conjunction with the present invention.

The present invention can be utilized, in any and/or all of the embodiments described herein, in conjunction with the buying, selling, bartering, and/or trading, of vehicles and/or any of the repair services, maintenance services, servicing services, parts, equipment, components, accessories, insurance policies, warranties, and/or other vehicle-related products and/or services, described herein as being provided by any of the respective manufacturers, dealers, service providers, repair facilities, service technicians, mechanics, parts providers, equipment providers, component providers, accessory providers, insurance providers, service payers, and/or intermediaries, described herein.

The present invention can be utilized, in any and/or all of the embodiments described herein, in conjunction with the buying, selling, bartering, and/or trading, of vehicles and/or any of the repair services, maintenance services, servicing services, parts, equipment, components, accessories, insurance policies, warranties, and/or other products or services, by and/or between any of the users, owners, operators, manufacturers, dealers, service providers, repair facilities, service technicians, mechanics, parts providers, equipment providers, component providers, accessory providers, insurance providers, service payers, and/or intermediaries, described herein.

In any and/or all of the embodiments described herein, any interactions, negotiations, and/or deals reached, between any of the parties, can be monitored and/or be recorded by the central processing computer 10 and be stored in the database 10H.

The communications networks and/or systems on, or over, which the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, broadband communication networks or systems, low earth orbiting satellite (LEOs) networks or systems, as well as in, or on any internets and/or intranets, the Internet, the World Wide Web, and any other suitable communication network or system.

In addition to any and/or all of the preferred embodiments described herein, the present invention can also be utilized in other preferred embodiments so as to incorporate, so as to improve upon, and/or so as to utilize, various teachings of the prior art. In this regard, Applicant hereby incorporates by reference herein the subject matter and teachings of the following U.S. patents: U.S. Pat. No. 5,737,711 which teaches and discloses and discloses a diagnosis system for motor vehicle; U.S. Pat. No. 5,670,939 which teaches and discloses and discloses a method for evaluation of the self-diagnosis of a controller in a motor vehicle; U.S. Pat. No. 5,631,831 which teaches and discloses and discloses a diagnosis method for vehicle systems; U.S. Pat. No. 5,569,922 which teaches and discloses and discloses a portable fuel analyzer for the diagnosis of fuel-related problems on-site at the vehicle service bay; U.S. Pat. No. 5,173,832 which teaches and discloses and discloses an electrical circuit, particularly an electronic power circuit for motor vehicle injection systems, with a function for the detection and diagnosis of faults, and the related method; U.S. Pat. No. 5,056,023 which teaches and discloses and discloses a diagnosis system for motor vehicle; U.S. Pat. No. 5,034,894 which teaches and discloses and discloses a self-diagnosis system for a motor vehicle; U.S. Pat. No. 4,996,643 which teaches and discloses and discloses a diagnosis system for a motor vehicle; U.S. Pat. No. 4,884,054 which teaches and discloses and discloses a self-contained motor vehicle maintenance interval monitor; U.S. Pat. No. 4,843,557 which teaches and discloses and discloses an overall diagnosis apparatus for vehicle-mounted control devices; U.S. Pat. No. 4,739,482 which teaches and discloses and discloses a motor vehicle maintenance interval monitor; U.S. Pat. No. 4,658,371 which teaches and discloses and discloses a fuel dispensing and vehicle maintenance system with on-board computer; U.S. Pat. No. 4,490,798 which teaches and discloses and discloses a fuel dispensing and vehicle maintenance system; and U.S. Pat. No. 4,267,569 which teaches and discloses and discloses a micro-computer system for control and diagnosis of motor vehicle functions.

The apparatus and method of the present invention, in any and/or all of the embodiments described herein, can be utilized for processing and/or for providing equipment information and/or industrial equipment maintenance information which facilitates the distribution and management of repair information, maintenance information, servicing information, as well as the any other industrial equipment information and/or industrial equipment-related information.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. An apparatus for processing vehicle information and/or vehicle maintenance information, comprising:
a memory device for storing at least one of vehicle diagnostic information, vehicle repair information, vehicle maintenance information, and vehicle servicing information;
a receiver for receiving information regarding at least one of a vehicle problem, a vehicle malfunction, and a vehicle state of disrepair;
a processor for processing said information regarding at least one of a vehicle problem, a vehicle malfunction, and a vehicle state of disrepair, in conjunction with at least one of vehicle diagnostic information, vehicle repair information, vehicle maintenance information, and vehicle servicing information, wherein said processor generates at least one of a diagnostic report, a repair report, a maintenance report, and a servicing report; and
a transmitter for transmitting at least one of said at least one of vehicle diagnostic information, vehicle repair information, vehicle maintenance information, and vehicle servicing information, to a communication device associated with an individual.

2. The apparatus of claim 1, wherein said processor processes information regarding a subsequent repair, a maintenance procedure, and a servicing procedure, and further wherein said processor stores said information regarding a subsequent repair, a maintenance procedure, and a servicing procedure, in said memory device.

3. The apparatus of claim 1, wherein said memory device contains information regarding at least one of a single vehicle and a plurality of vehicles.

4. The apparatus of claim 1, wherein the communication device is at least one of a personal computer, a home computer, a server computer, a network computer, a hand-held computer, a palmtop computer, a laptop computer, a personal communication device, a personal digital assistant, a telephone, a digital telephone, a display telephone, a video telephone, a videophone, a 3G telephone, a television, an interactive television, a beeper, a pager, and a watch.

5. The apparatus of claim 1, wherein said memory device comprises a comprehensive vehicle maintenance database.

6. The apparatus of claim 1, wherein said processor generates at least one of a maintenance reminder message and a service reminder message.

7. The apparatus of claim 6, wherein said at least one of a maintenance reminder message and a service reminder message is transmitted to the communication device associated with the individual.

8. The apparatus of claim 1, wherein said processor initiates a communication to at least one of a vehicle computer and a vehicle electronic command computer, and further wherein said apparatus uploads vehicle information from said at least one of a vehicle computer and a vehicle electronic command computer.

9. The apparatus of claim 1, wherein said apparatus is utilized in conjunction with at least one of a communication network, a wireless communication network, the Internet, and the World Wide Web.

10. The apparatus of claim 1, wherein said processor determines a feasibility of performing at least one of a repair, a maintenance procedure, and a servicing procedure, on the vehicle.

11. A method for processing vehicle information and/or vehicle maintenance information, comprising:
storing at least one of vehicle diagnostic information, vehicle repair information, vehicle maintenance information, and vehicle servicing information;
receiving information regarding at least one of a vehicle problem, a vehicle malfunction, and a vehicle state of disrepair;
processing said information regarding said at least one of a vehicle problem, a vehicle malfunction, and a vehicle state of disrepair, in conjunction with at least one of vehicle diagnostic information, vehicle repair information, vehicle maintenance information, and vehicle servicing information;
generating at least one of a diagnostic report, a repair report, a maintenance report, and a servicing report; and
transmitting at least one of said at least one of vehicle diagnostic information, vehicle repair information, vehicle maintenance information, and vehicle servicing information, to a communication device associated with an individual.

12. The method of claim 11, further comprising:
processing information regarding a subsequent repair, a maintenance procedure, and a servicing procedure; and
storing said information regarding a subsequent repair, a maintenance procedure, and a servicing procedure.

13. The method of claim 11, wherein the communication device is at least one of a personal computer, a home computer, a server computer, a network computer, a hand-held computer, a palmtop computer, a laptop computer, a personal communication device, a personal digital assistant, a telephone, a digital telephone, a display telephone, a video telephone, a videophone, a 3G telephone, a television, an interactive television, a beeper, a pager, and a watch.

14. The method of claim 11, further comprising:
generating at least one of a maintenance reminder message and a service reminder message.

15. The method of claim 14, wherein said at least one of a maintenance reminder message and a service reminder message is transmitted to the communication device associated with the individual.

16. The method of claim 15, further comprising:
initiating a communication to at least one of a vehicle computer and a vehicle electronic command computer; and
uploading vehicle information from said at least one of a vehicle computer and a vehicle electronic command computer.

17. The apparatus of claim 11, wherein said method is utilized in conjunction with at least one of a communication network, a wireless communication network, the Internet, and the World Wide Web.

18. An apparatus for processing vehicle information and/or vehicle maintenance information, comprising:
a memory device for storing information regarding at least one of vehicle service providers, a provider of specialized services, vehicle parts providers, vehicle equipment providers, vehicle component providers, and vehicle accessory providers;
a receiver for receiving a request for at least one of a vehicle service provider, a provider of specialized services, a vehicle parts provider, a vehicle equipment providers, a vehicle component providers, and a vehicle accessory provider;
a processor for processing said request in conjunction with said information regarding at least one of vehicle service providers, a provider of specialized services, vehicle parts providers, vehicle equipment providers, vehicle component providers, and vehicle accessory providers, wherein said processor generates at least one of a user notification message to notify a user of information in response to said request and a provider notification message to notify a provider of said request; and
a transmitter for transmitting at least one of said user notification message to a communication device associated with a user and said provider notification message to a communication device associated with a provider.

19. The apparatus of claim 18, wherein said processor stores information regarding a transaction between the user and a provider.

20. The apparatus of claim 18, wherein said apparatus is at least one of a central processing computer, a server computer, and a network computer.
